(19) United States
(12) Patent Application Publication
(10) Pub. No.: US 2023/0169466 A1
(43) Pub. Date: Jun. 1, 2023

(54) Data Management System for a Plurality of Organizations

(71) Applicant: People Center, Inc., San Francisco, CA (US)

(72) Inventors: Aditya Prakash, Bangaluru (IN); Kevinkumar Amipara, Rajkot (IN); Sachin Aralasurali Suryanarayana, Bangalore (IN); Sankaranarayanan Mahadevan, Bangalore (IN); Sanket Singhal, Ranchi (IN); Shubham Choudhary, Bangalore (IN); Vishal Sah, New Delhi (IN)

(21) Appl. No.: 17/589,311

(22) Filed: Jan. 31, 2022

(30) Foreign Application Priority Data
Nov. 30, 2021 (IN) 202121055412

(51) Int. Cl. G06Q 10/10; G06Q 40/08

(52) U.S. Cl. CPC G06Q 10/1057; G06Q 40/08

(57) ABSTRACT

An insurance management system of a professional employer organization (PEO) is disclosed. The system can include a database that stores organizational data associated with a plurality of organizations that are part of a PEO. The system can obtain first organizational data associated with a first organization of the plurality of organizations. The first organization data can include employee data of the first organization. Additionally, the system can determine a risk assessment score of the first organization based on the employee data of the first organization. Moreover, the system determines a plurality of insurance plans for the first organization based on the risk assessment score of the first organization. Furthermore, the system can rank the plurality of insurance plans based on the value and the coverage plan of each insurance plan. Subsequently, the system can present an insurance report based on the ranking of the plurality of insurance plans.

### PRIORITY CLAIM

The present application is based on and claims priority to Indian Provisional Application No. 202121055412, having a filing date of Nov. 30, 2021, which is incorporated by reference herein.

### FIELD

The present disclosure relates generally to data management systems for a plurality of organizations. More particularly, the present disclosure relates to managing insurance policy enrollment for employees of an organization that is part of a professional employer organization.

### BACKGROUND

Some existing data management systems utilize a database for a plurality of organizations that can be maintained by a single host entity (e.g., a professional employer organization (PEO)). The single host entity can be responsible for managing and applying the data of the plurality of organizations (e.g., client organizations of the PEO), as well as data of the host entity, where all such data is stored in the database of the host entity.

A professional employer organization (PEO) enables organizations, especially small and mid-size businesses, to provide their employees with access to better, more affordable benefits and streamline administrative human resource (HR) functions, such as, but not limited to, payroll, benefits, compliance, and workers' compensation.

The HR demands of running a business can be time consuming, especially with the increase in remote work, which requires managing compliance across multiple states. Additionally, in order to recruit and retain top talent, organizations need to compete with the large-size organization by offering top-tier benefits. A PEO, using the data management system, can automate some of the HR functions, and also provide cost savings to employees by grouping multiple organizations in order to obtain economies of scale and reduce cost.

### SUMMARY

Aspects and advantages of embodiments of the present disclosure will be set forth in part in the following description, or can be learned from the description, or can be learned through practice of the embodiments.

One example aspect of the present disclosure is directed to a computer system that implements and includes one or more processors, one or more databases, and one or more memory devices. The one or more databases can store organizational data associated with a plurality of organizations, wherein the plurality of organizations are part of a professional employer organization (PEO). The one or more memory devices can store instructions that, when executed by the one or more processors, cause the computer system to perform operations. The operations can include obtaining first organizational data associated with a first organization of the plurality of organizations. The first organization data can include employee data of the first organization. Additionally, the operations can include determining a risk assessment score of the first organization based on the employee data of the first organization. Moreover, the operations can include determining a plurality of insurance plans for the first organization based on the risk assessment score of the first organization. Each insurance plan in the plurality of insurance plans can have a value (e.g., price) and a coverage plan. Furthermore, the operations can include ranking the plurality of insurance plans based on the value and the coverage plan of each insurance plan in the plurality of insurance plans. Subsequently, the operations can include presenting, using a user interface, an insurance report based on the ranking of the plurality of insurance plans.

Another example aspect of the present disclosure is directed to a computer-implemented method for managing insurance policies. For example, the method performed by one or more computing devices can access organizational data associated with a plurality of organizations. The organizational data can be stored in one or more databases. The plurality of organizations can be part of a professional employer organization. Additionally, the method can include obtaining, by the one or more computing devices, first organizational data associated with a first organization of the plurality of organizations. The first organization data can include employee data of the first organization. Moreover, the method can include determining, by the one or more computing devices, a risk assessment score of the first organization based on the employee data of the first organization. Furthermore, the method can include determining, by the one or more computing devices, a plurality of insurance plans for the first organization based on the risk assessment score of the first organization. Each insurance plan in the plurality of insurance plans can have a value and a coverage plan. The method can further include ranking, by the one or more computing devices, the plurality of insurance plans based on the value and the coverage plan of each insurance plan in the plurality of insurance plans. Subsequently, the method can include presenting, using a user interface, an insurance report based on the ranking of the plurality of insurance plans.

Another example aspect of the present disclosure is directed to one or more tangible non-transitory computer-readable media storing computer-readable instructions that, when executed by one or more processors, cause the one or more processors of a computing system to perform operations. For example, the operations can include accessing, from one or more databases, organizational data associated with a plurality of organizations, wherein the plurality of organizations are part of a professional employer organization. Additionally, the operations can include obtaining first organizational data associated with a first organization of the plurality of organizations, the first organization data including employee data of the first organization. Moreover, the operations can include determining a risk assessment score of the first organization based on the employee data of the first organization. Furthermore, the operations can include determining a plurality of insurance plans for the first organization based on the risk assessment score of the first organization, each insurance plan in the plurality of insurance plans having a value and a coverage plan. The operations can further include ranking the plurality of insurance plans based on the value and the coverage plan of each insurance plan in the plurality of insurance plans. Subsequently, the operations can include causing the presentation of an insurance report on a user interface, the insurance report being generated based on the ranking of the plurality of insurance plans.

In some instances, the operations can further include accessing second organizational data associated with a second organization of the plurality of organizations. The second organizational data can have a risk assessment score for the second organization. Additionally, the operations can include transmitting, to an insurance carrier for the PEO, the risk assessment score of the first organization and the risk assessment score of the second organization. Moreover, the operations can include receiving from the insurance carrier for the PEO, an insurance plan having a coverage plan and a value. The insurance plan is based on the risk assessment score of the first organization and the risk assessment score of the second organization. The received insurance plan from the insurance carrier for the PEO can be included in the plurality of insurance plans that is determined, ranked, and presented.

In some instances, the first organization and a second organization are part of a professional employer organization (PEO). For example, the operations further include obtaining second organizational data associated with the second organization. The second organization data can include employee data of the second organization. Additionally, the operations can include determining a risk assessment score of the second organization based on the employee data of the second organization. Furthermore, the determination of the plurality of insurance plans for the first organization can be further based on the risk assessment score of the second organization.

In some instances, the operations can further include determining a recommended insurance plan from the plurality of insurance plans based on the ranking of the plurality of insurance plans. The recommended insurance plan being associated with a preferred insurance carrier. Additionally, the operations can include transmitting, to the preferred insurance carrier, insurance information derived from the employee data of the first organization to enroll the first organization in the recommended insurance plan. Moreover, the first organization data can include a current insurance plan, and the operations can further include transmitting, to a current insurance carrier associated with the current insurance plan, cancelation information derived from the employee data of the first organization to cancel the current insurance plan. The insurance information and the cancelation information can be derived from the employee data of the first organization without requiring additional user input from an employee of the first organization. Furthermore, in some implementations, the insurance information transmitted to the preferred insurance carrier occurs after a certain period of time has lapsed since the report was presented on the user interface.

In some instances, the operations can further include receiving a user input associated with the selection of a selected insurance plan from the plurality of insurance plans. Subsequently, the operation can include enrolling the first organization in the selected insurance plan in response to receiving the user input.

In some instances, the first organizational data includes a current insurance plan. Additionally, the ranking of the plurality of insurance plans is further based on a comparison of the plurality of insurance plans with the current insurance plan.

In some instances, the operations can further include determining a tier for the first organization rating based on the risk assessment score of the first organization. For example, the value for each insurance plan in the plurality of insurance plans can be based on the tier rating.

In some instances, the first organization data includes a current insurance plan, and the operations can further include transmitting, to an insurance carrier for the PEO, coverage data derived from the current insurance plan. Additionally, the operations can include receiving from the insurance carrier for the PEO, an insurance plan having a coverage plan and a value, where the coverage plan is similar to the coverage data. The received insurance plan from the insurance carrier for the PEO can be part of the plurality of insurance plans that is determined, ranked, and presented.

In some instances, the first organization data can include a current insurance plan associated with a current insurance carrier. The operations can further include transmitting, to the insurance carrier, coverage data derived from the current insurance plan and the employee data of the first organization to automatically renew the current insurance plan.

Other aspects of the present disclosure are directed to various systems, apparatuses, non-transitory computer-readable media, user interfaces, and devices for providing triggers in a system of record. These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example environment including a computing system that performs operations, according to example embodiments of the present disclosure.

FIG. 2 depicts a block diagram of an example of a computing device, according to example embodiments of the present disclosure.

FIG. 3 depicts a block diagram of an example computing environment including multiple computing systems, according to example embodiments of the present disclosure.

FIG. 4 depicts a flow diagram of an example method for generating an insurance report in a system that manages organizational data, according to example embodiments of the present disclosure.

FIG. 5 depicts a flow diagram of an example method for obtaining an insurance plan from an insurance carrier, according to example embodiments of the present disclosure.

FIG. 6 depicts a flow diagram of an example method for automatically enrolling in an insurance plan and automatically canceling an old insurance plan, according to example embodiments of the present disclosure.

FIG. 7 depicts a scenario of an organization or employee leaving a PEO, according to example embodiments of the present disclosure.

FIG. 8 depicts another scenario of an organization or employee leaving a PEO, according to example embodiments of the present disclosure.

Reference numerals that are repeated across plural figures are intended to identify the same features in various implementations.

### DETAILED DESCRIPTION

Generally, the present disclosure is directed to improved computer systems, computer applications, computer-implemented methods, user interfaces, and/or services for managing insurance policy enrollment in a system of record that manages organizational data and performing an action associated with a generation of a report. In some instances, the generated report can be presented to a user, and the insurance management system can seamlessly enroll an employee of an organization in an insurance policy. For example, the report can be automatically generated based on a trigger. The activation of the trigger can be based on the change of an employee status (e.g., marriage, new dependent), which can result in the modification of the insurance policy of the employee. Additionally, the insurance management system can also unenroll, without human interactions, an employee from an old insurance policy after enrolling the employee in a new insurance policy.

According to some embodiments, an insurance management system of a professional employer organization (PEO) can enable organizations (e.g., small to midsize businesses) to provide their employees with access to better and more affordable healthcare benefits. For example, the PEO can provide cost savings to an employee by grouping multiple organizations in order to obtain economies of scale and reduce cost.

Additionally, in conventional systems, organizations would need to fully outsource all of their HR functions to a PEO when deciding to join the PEO. However, using the techniques described herein, an organization can automate some of the HR functions (e.g., health insurance enrollment) in order to keep sensitive information within the organization while benefiting from the time savings, advisory services, and better benefits associated with using a PEO. For example, the management system described herein can specialize in payroll, benefits, HR, and labor compliance services, allowing an organization to streamline employee-related administrative duties in order to better allocate time and resources for high value activities. In some instances, the PEO can co-employ the employees of the organization, which allows the management system of the PEO to automate tasks like running payroll, enrolling employees in benefits, managing compliance with current labor and employment laws, and more. As a result, the PEO can assist organizations obtain higher employee satisfaction and lower employee turnover.

Furthermore, the PEO can co-employ employees of an organization for administrative purposes, such as paying employees and filing payroll taxes. The organization that joins the PEO retains full control over hiring decisions, benefit plans and designs are offered to employees, and other relevant human resources decisions. The PEO can act as a co-employer by co-employing workers on record for tax purposes and usually processes wages, benefits, withholdings, and taxes under their federal employer identification number.

Moreover, the PEO can manage premium payments for an organization based on the pricing obtained from the insurance carrier or underwriter. The pricing of these small groups varies based on the risk assessment score of the benefits-eligible employees. For example, the management system reports the employee data to the insurance carriers in order to obtain a value (e.g., price quote) for each employee of the plurality of organizations. By considering all of the employees of the plurality of organizations as part of a large group plan of the PEO entity, the management system can obtain better pricing for each employee by leveraging the economies of scale associated with the PEO.

According to some embodiments, a management system of a PEO to manage insurance for organizations is described herein. For example, a plurality of organizations (e.g., small, and medium companies) can join a PEO and the management system can negotiate on behalf of the plurality of organizations to obtain better rates and insurance plans. Additionally, the management system can automatically transition an organization from being a non-PEO organization to being a PEO organization, and vice-versa.

In some instances, the organizations can be small companies that may have fewer than 50 benefits-eligible employees. The management system allows employees of these organizations to become co-employed by the PEO, which enables these organizations to access coverage under the PEO's large group plan. The pricing of these organizations varies based on the employee data (e.g., census) of their benefits-eligible employees. The system can manage premium collections from each organization based on their underwriting. While reporting data (e.g., insurance data) to carriers, the system reports data considering all clients as a large group plan of the PEO entity.

For example, when an organization wants to join a PEO, the system can generate a report with different insurance plans and pricing if the organization joins the PEO. When the organization's employee data is already stored in the system, then the report gets automatically generated without any additional input from the organization. Alternatively, if the organization is a new customer, then the system obtains the employee data of the organization. The employee data includes information that the insurance underwriter requires in order to provide a quote for different insurance plans.

The management system can collect employee data (e.g., census info) from an organization, send the census information to an insurance carrier to obtain a price quote. In some instances, the insurance carrier or the system can determine a risk assessment score for the employees of the organization based on the census data. The price quote can be further determined based on the risk assessment score. The insurance carrier can be the underwriter and the broker of record for the organization if the organization joins the PEO.

In some instances, the organizations are categorized in tier-levels by the system, and the insurance rate can be determined by the tier-level. For example, the system can generate a plurality of different insurance plans (e.g., 50 different insurance plans) for an organization that has a specific tier-level. Additionally, when the PEO is the underwriter, using empirical data and training data, the management system can provide more accurate pricing for different insurance plans.

In some instances, the pricing can be determined based on the risk assessment score, the employee data (e.g., information about the employees and their dependents), previous health history, and current health insurance plan. The system can determine a tier-level, a value (e.g., price) based on the tier-level, and then generate a report. The report can include a breakdown of the pricing and a recommended plan. Additionally, the report can include plans that are similar to the current plan of the organization. The plurality of plans in the report can be ranked using a machine-learned model. Some of the data inputted into the model can be obtained or derived from other third-party applications that the organization is associated with. The machine-learned model can be trained (e.g., modifying the parameters of the algorithm) as the system obtains more data in order to provide real-time quotes for different insurance plans from different insurance carriers.

For example, the insurance carrier or underwriter can determine a risk assessment score based on the employee data of the organization. Additionally, the insurance carrier or underwriter can determine a tier value based on the risk assessment score and use the tier value to determine pricing for different insurance plans. The insurance carrier or underwriter can transmit the risk assessment score, the tier value, and the pricing for the different insurance plans to the PEO. The management system of the PEO can obtain the different insurance plans, which include the determined pricing, from the insurance carrier or underwriter. Alternatively, in some embodiments, the management system of the POE can directly determine the risk assessment score, the tier value, and the pricing for the different insurance plans pricing. Furthermore, the different insurance plans can be ranked, by the management system using a model (e.g., machine-learned model), and the ranked plans can be presented to the employees of the organization.

The system can provide insurance price quotes to organizations by interacting directly with the insurance carriers. The organizations that join PEO will be presented, by the management system, reports with different insurance plans with prices. As previously mentioned, as a benefit of joining the PEO, the organization will have access to better benefits at cheaper costs. The system prepares a price comparison with the organization's current insurance plan and the potential insurance plans as part of the PEO. The report can assist the organization in determining whether to join the PEO.

The management system can seamlessly present pricing information to organizations that are already using the management system for managing their insurance, because the employee data and the current insurance data can already be stored in a database of the management system. For new organizations (e.g., organizations that are interested in joining the PEO), the management system provides an interface for the organization to enter their current coverage information to generate cost comparison reports.

Once the management system obtains an organization's current coverage information, the system sends (e.g., transmits) this information to an insurance carrier (e.g., insurance underwriter) to do insurance underwriting for the PEO group. The insurance carrier can use the employee data (e.g., census reports) which contain insurance plans opted by each employee and their dependents, their age, and company information. The management system can provide a portal for the insurance carrier to provide tier-level for the organization or risk assessment scores for each group based on which the management system determines the organizations for PEO insurance benefits plans. Alternatively, in some embodiments, the management system can determine the pricing for the different insurance plans based on the employee data using a machine-learned model.

The management system can provide a tool to generate a plan comparison report comparing the group's existing coverage with PEO coverage along with costs. The report also recommends PEO recommended plan corresponding to each current plan based on multiple plans attributes like plan type, copay, deductible, etc. based on which prospective client can decide to join PEO.

The management system assists with plan selection and employee enrollments. Once a prospective client decides to join PEO, the management system presents a user interface for the insurance selection. Organizations can select plans which they want to offer to their employees. Additionally, if the organization is already using the management system to manage their current insurance coverage, then the management system can assist the organization with canceling their prior coverage by generating carrier forms.

Once the HR administrator of the organization completes setting up plans with PEO coverage, employees of the organization get an option to make their plan selection. Employees can either enroll in any available plan or waive the coverage.

The management system can transmit coverage data to insurance carriers. When reporting enrollment and coverage data per employee to the insurance carriers, the management system consolidates all the employee's data for various different client companies and reports to carriers considering they are employees of a single PEO entity. In this way, although the management system is managing coverage for a plurality of organizations, the enrollment information gets reported as they are part of a large group.

In some instances, the management system can perform PEO renewals. During renewal, the employee data is submitted to the insurance carrier to determine if the tier-level has changed. If the tier-level has changed, the report can include updated pricing based on the new tier-level. If the tier-level has not changed, then the management system sends the different insurance plans to select. If the employees do not select a new plan, then the management system can automatically renew the same insurance plan. On renewal, all active organizations get an option to choose new plans for the upcoming year. Once the HR administrator of the organization completes plan selection, all eligible employees get an option to make their plan selection. Client companies can join and start coverage any time throughout the year as while reporting coverage information to the carrier, all employees belong to one large group of PEO entities. Additionally, new organizations that have recently joined the PEO can be categorized as new employees get hired into existing groups of the PEO.

The management system can perform premium payment collection. Each month the management system can charge insurance premiums from organizations based on their enrolled employees and has the ability to pay it to carriers. Once an employee is enrolled in the plan, the management system can determine the cost of the insurance per employee and obtain from the organization the allocation of the cost of coverage between the organization and employees. The system can collect the insurance premium and pay the PEO on behalf a plurality of clients without any manual computation.

The management system can perform termination from PEO and PEO Insurance coverage. When a PEO client company decides to leave PEO, the management system helps them set up coverage from other available carriers and can manage their non-PEO insurance coverage post-termination from PEO. If it decides to leave PEO, the management system can manage non-PEO coverage (benefits).

According to some embodiments, the management system of the PEO can automate employment-related HR administrative work, including payroll, employee benefits, HR compliance. With regards to payroll, the management system can manage paying employees, withholding, and paying taxes, and more. The system allows an organization to automate this in-house and drastically reduce the time required for each pay run. With regards to employee benefits, as a large group, the PEO can leverage its economies of scale to negotiate pricing with providers, streamline employee enrollment, process claims, and more. With regards to HR compliance, the PEO can assist organizations to be compliant with labor and employment laws. The laws can be complicated, different in every state, and often changing. The management system of the PEO assists organizations to follow the rules and avoid costly fines. The management system brings technology, HR expertise, and established processes that allows organizations to save time on administrative functions and stay business compliant.

Furthermore, the management system of the PEO can save money through economies of scale. Given that the PEO can co-employ employees from different organizations, the management system can obtain pricing quotes from different insurance providers in order to obtain the best value for high-quality benefits for the employees of these different organizations (e.g., small, and medium size business) which can often lower employment costs. By co-employing the employees of a plurality of organizations, the management system can harness the buying power reserved for much larger companies and provide access to more robust benefits for small business employees, allowing them to access a wider range of high quality, affordable options. By co-employing employees of a plurality of organizations, the management system can negotiate rates with insurance companies and other benefits providers. An example of the negotiation techniques can include the management system requesting multiple quotes from different insurance providers, so that the different insurance providers can compete with each other to provide the lowest price. Additionally, by automating the price quoting request from an insurance carrier, the management system saves time and resources for the HR team of an organization. With automation, the HR team does not need to file paperwork, negotiate with benefits providers, and sift through ever-changing employer-related laws. In some instances, the management system of the PEO can negotiate directly with health insurance carriers to provide access to more plans and coverage typically only available in the large group market, giving organizations the combined power of an all-in-one HR and IT platform with the benefits of a PEO.

According to some embodiments, the management system can provide access to the following benefits to an organization: healthcare plans, life insurance and disability insurance; worksite benefits, mental health support; retirement plans; commuter benefits; dependent care. Often, these benefits end up being less costly for employees. Additionally, the management system of the PEO provides tools that help organizations to stay in compliant with the different healthcare laws and regulations (e.g., Affordable Care Act (ACA), COBRA, FSA, HSA, and other benefits-related laws) by automating the process and sending alerts to the organizations when the laws and regulations change.

The management system can save time by automating HR administrative duties. The system can assist with payroll, benefits, and general employee management. With regards to payroll, the system can track hours and PTO, paying employees, reporting wages, withholding, and paying payroll taxes, and pay vendors and contractors. With regards to benefits, the system can streamline benefits from negotiating with providers to enrolling employees and processing claims. With regards to general employee management, the system can administer unemployment and workers' compensation, manage leave of absence requests, create an employee handbook, and assist with performance evaluation appraisals. Additionally, the management system can streamline and automate many of the HR functions, such as but not limited to, setting up new hires' accounts and devices, running payroll, and enrolling employees in benefits.

The management system of the PEO can allow organizations to hire remotely and provide premium HR and benefits with reduced cost and reduced compliance risk. For example, the PEO can partner with leading insurance carriers to provide access to premium benefits, often at lower costs.

With reference to the Figures, example embodiments of the present disclosure will be discussed in further detail.

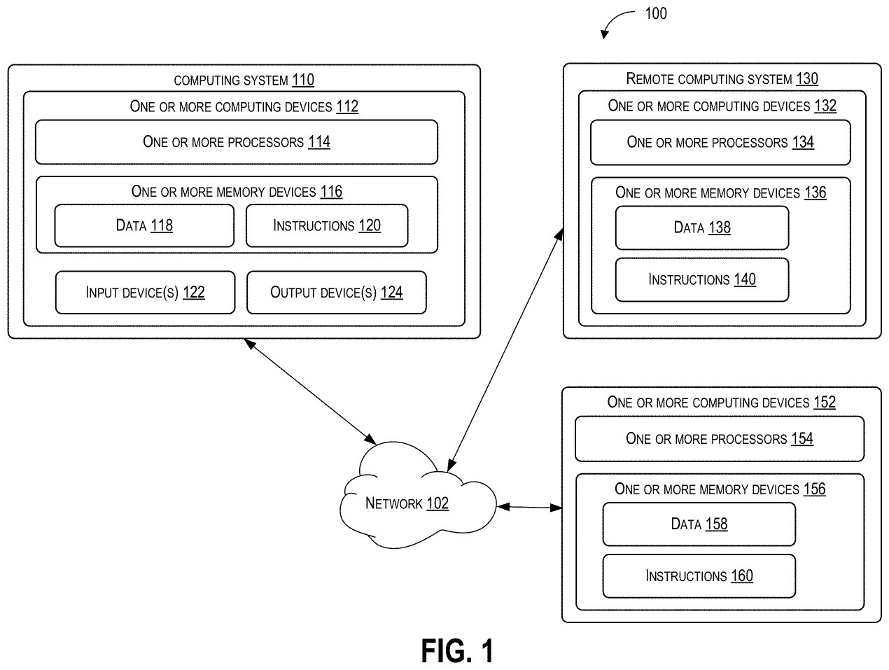

FIG. 1 depicts a block diagram of an example environment 100 including a computing system 110 that performs operations according to example embodiments of the present disclosure. The environment 100 includes a network 102, a computing system 110, one or more computing devices 112, one or more processors 114, one or more memory devices 116, data 118, instructions 120, a remote computing system 130, one or more computing devices 132, one or more processors 134, one or more memory devices 136, data 138, instructions 140, one or more computing devices 152, one or more processors 154, one or more memory devices 156, data 158, and instructions 160.

The network 102 can include any type of communications network. For example, the network 102 can include a local area network (LAN), a wide area network (WAN), an intranet, an extranet, and/or the internet. Further, the network 102 can include any number of wired or wireless connections and/or links that can be used to communicate with one or more computing systems (e.g., the computing system 110 and/or the remote computing system 130) and/or one or more devices (e.g., the one or more computing devices 152). Communication over the network 102 can be performed via any type of wired and/or wireless connection and can use a wide variety of communication protocols (e.g., TCP/IP, HTTP, SMTP, FTP), encodings or formats (e.g., HTML, XML), and/or protection schemes (e.g., VPN, secure HTTP, SSL).

The computing system 110 can include any combination of systems and/or devices including one or more computing systems (not shown) and/or one or more computing devices 112. Further, the computing system 110 may be connected (e.g., networked) to one or more computing systems (e.g., remote computing system 130) and/or one or more computing devices (e.g., one or more computing devices 132, 152) via the network 102. The computing system 110 may operate in various different configurations including as a server or a client machine in a client-server network environment, or as a peer machine in a peer-to-peer (or distributed) network environment. Though the computing system 110 is depicted in FIG. 1 as a single device, the computing system 110 can include any collection or combination of devices that individually or in combination with other devices, execute a set of one or more instructions to perform any one or more of the operations discussed herein.

In this example, the computing system 110 includes one or more computing devices 112. The one or more computing devices 112 can include any type of computing device. For example, the one or more computing devices 112 can include a personal computing device (e.g., a desktop computing device), a mobile computing device (e.g., a smartphone or tablet device), a wearable computing device (e.g., a smartwatch device), an embedded computing device, a web appliance, a server computing device, a network router, a switch, a bridge, or any device capable of executing a set of instructions (e.g., any combination of instructions which can include sequential instructions and/or parallel instructions) associated with one or more operations and/or one or more actions to be performed by the computing system 110 or any of the constituent components and/or devices of the computing system 110.

Any of the one or more computing devices 112 can include the one or more processors 114. The one or more processors 114 can include any processing device (e.g., a processor core, a microprocessor, an ASIC, a FPGA, a controller, or a microcontroller) and can include one processor or multiple processors that may be operatively connected. In some embodiments, the one or more processors 114 may include one or more complex instruction set computing (CISC) microprocessors, one or more reduced instruction set computing (RISC) microprocessors, one or more very long instruction word (VLIW) microprocessors, and/or one or more processors that are configured to implement other instruction sets.

The one or more computing devices 112 can include the one or more memory devices 116. The one or more memory devices 116 can be used to store data and/or information and can include one or more computer-readable media, one or more non-transitory computer-readable storage media, and/or one or more machine-readable media. Though the one or more memory devices 116 are depicted in FIG. 1 as a single unit (e.g., a single medium), the computer-readable storage media can include a single medium or multiple media (e.g., a centralized or distributed database, and/or associated caches and servers) that store one or more sets of instructions. Further, the computer-readable storage media can include any medium that is capable of storing, encoding, and/or carrying a set of instructions for execution by a computing device and which may cause the computing device to perform any of the one or more operations described herein. In some embodiments, the computer-readable storage media can include one or more solid-state memories, one or more optical media, and/or one or more magnetic media. By way of example, the one or more memory devices 116 can include any combination of random-access memory (RAM), read-only memory (ROM), EEPROM, EPROM, one or more flash memory devices, and/or one or more magnetic storage devices (e.g., one or more hard disk drives).

The one or more processors 114 can be configured to execute one or more instructions to perform the operations described herein. Further, the one or more memory devices 116 can store the data 118 and/or the instructions 120, which can be executed by the one or more processors 114 to cause the one or more computing devices 112 to perform one or more operations. For example, the one or more operations performed by the one or more processors 114 can include obtaining organizational data associated with a first organization of the plurality of organizations, determining a risk assessment score of the first organization based on the employee data of the first organization, determining a plurality of insurance plans for the first organization based on the risk assessment score of the first organization, ranking the plurality of insurance plans based on the price and the coverage plan of each insurance plan, and presenting an insurance report based on the ranking of the plurality of insurance plans.

The data 118 can include organizational data (e.g., organizational data that can include one or more organizational records), one or more data structures defining, describing, and/or otherwise associated with the organizational data, rule data (e.g., rule data that includes one or more rules used to configure an application policy, one or more rules maintained by or otherwise associated with an organizational data management system, etc.), application data (e.g., application data associated with a plurality of applications including one or more third-party applications and/or one or more intra-organizational applications), third-party integration data (e.g., data providing configuration and/or other information for performing integration and synchronization with each of one or more different third-party systems and/or applications), employee data, insurance data, price data, data that includes instructions in a custom computer language (e.g., a custom query language based on organizational data), data that includes rules associated with the custom computer language, and/or other types of data. Further, the instructions 120 can include one or more instructions to use data including the data 118 to perform any one or more of the various operations described herein. In some embodiments, the one or more memory devices 116 can be used to store one or more applications that can be operated by the one or more processors 114. The data 118, the instructions 120, and/or the one or more applications can be associated with an organization. Further, the computing system 110 may be associated with an organization and may be configured to manage one or more applications.

Any of the one or more computing devices 112 can include one or more input devices 122 and/or one or more output devices 124. The one or more input devices 122 can be configured to receive input (e.g., user input) and can include one or more touch screens, one or more keyboards, one or more pointing devices, (e.g., mouse device), one or more buttons, one or more microphones, and/or one or more cameras. The one or more output devices 124 can include one or more display devices, one or more loudspeaker devices, one or more haptic output devices. By way of example, the one or more output devices 124 can be used to display a graphical user interface via a display device that can include a touch screen layer that is configured to detect one or more inputs (e.g., one or more user inputs). The one or more processors 114 may perform one or more operations based at least in part on the one or more inputs.

The remote computing system 130 includes one or more computing devices 132. Each of the one or more computing devices 132 can include one or more processors 134, one or more memory devices 136, the data 138, and/or the instructions 140. The remote computing system 130 can include any of the attributes and/or capabilities of the computing system 110. Further, the remote computing system 130 can communicate with one or more devices and/or one or more systems via the network 102. In some embodiments, the remote computing system 130 can include one or more applications (e.g., computer software applications comprising computer instructions) that can be stored and/or executed by the remote computing system 130.

One or more computing devices 152 (e.g., user devices or any other types of devices) can include one or more processors 154, one or more memory devices 156, the data 158, and/or the instructions 160. Such one or more computing devices 152 may include any of the attributes and/or capabilities of the one or more computing devices 112, 132. Further, such one or more computing devices 152 can communicate with one or more devices and/or one or more systems via the network 102. In some embodiments, the one or more computing devices 152 can include one or more applications (e.g., computer software applications comprising computer instructions) that can be stored and/or executed by such one or more computing devices 152.

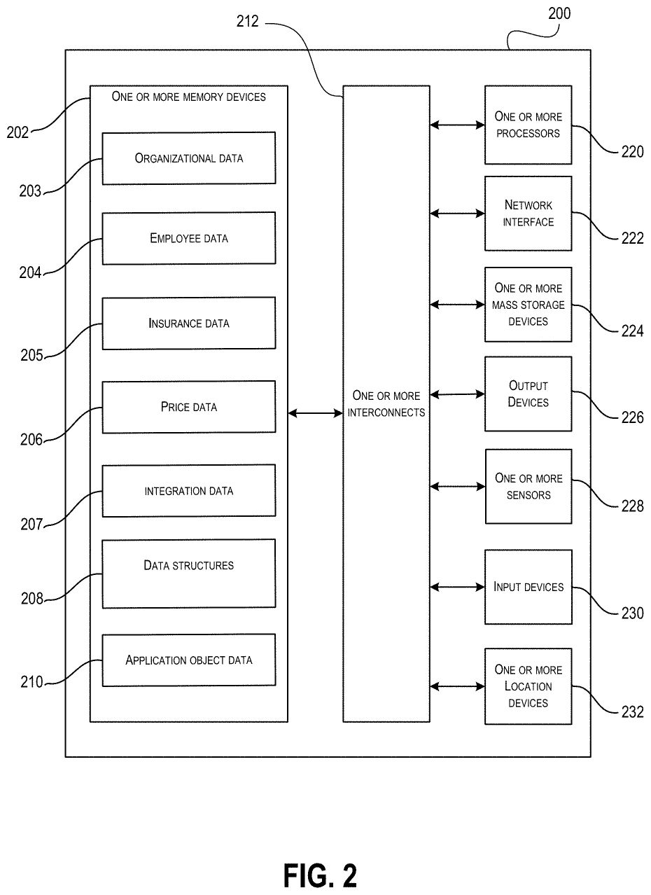

FIG. 2 depicts a block diagram of an example computing device 200 according to example embodiments of the present disclosure. The computing device 200 can include one or more attributes and/or capabilities of the computing system 110, the remote computing system 130, the one or more computing devices 152, and/or the computing device 200. Furthermore, the computing device 200 can be configured to perform one or more operations and/or one or more actions that can be performed by the computing system 110, the remote computing system 130, the one or more computing devices 152, and/or the computing device 200.

As shown in FIG. 2, the computing device 200 can include one or more memory devices 202, organizational data 203, employee data 204, insurance data 205, price data 206, integration data 207, data structures 208, application object data 210, one or more interconnects 212, one or more processors 220, a network interface 222, one or more mass storage devices 224, one or more output devices 226, one or more sensors 228, one or more input devices 230, and/or one or more location devices 232.

The one or more memory devices 202 can store information and/or data (e.g., organizational data 203, employee data 204, insurance data 205, price data 206, integration data 207, data structures 208, application object data 210, and/or any other types of data). Further, the one or more memory devices 202 can include one or more non-transitory computer-readable storage media, including RAM, ROM, EEPROM, EPROM, flash memory devices, magnetic disks, and any combination thereof. The information and/or data stored by the one or more memory devices 202 can be executed by the one or more processors 220 to cause the computing device 200 to perform one or more operations described herein.

The organizational data 203 can include one or more portions of data (e.g., the data 118, the data 138, and/or the data 158, which are depicted in FIG. 1) and/or instructions (e.g., the instructions 120, the instructions 140, and/or the instructions 160, which are depicted in FIG. 1) that are stored respectively in any of the one or more memory devices 116, 136, 156. The organizational data 203 also can include information associated with one or more applications (e.g., one or more third-party applications), one or more organizational records and/or one or more organizational policies. In some embodiments, the organizational data 203 can be received from one or more computing systems (e.g., the remote computing system 130 depicted in FIG. 1) which can include one or more computing systems that are remote (e.g., in another room, building, part of town, city, or nation) from the computing device 200. In some instances, the organization data 203 can include the employee data 204, the insurance data 205, the price data 206, the integration data 207, the data structures 208, and the application object data 210.

The employee data 204 can include one or more portions of data (e.g., the data 118, the data 138, and/or the data 158, which are depicted in FIG. 1) and/or instructions (e.g., the instructions 120, the instructions 140, and/or the instructions 160, which are depicted in FIG. 1) that are stored in the one or more memory devices 116, the one or more memory devices 136, and/or the one or more memory devices 156, respectively. The employee data 204 can include employee records and information about their dependents. The employee data 204 can include any information that may be required by an insurance carrier to provide insurance coverage. In some embodiments, the price data 206 can be received from one or more computing systems (e.g., the remote computing system 130 depicted in FIG. 1), which can include one or more computing systems that are remote from the computing device 200.

The insurance 205 can include one or more portions of data (e.g., the data 118, the data 138, and/or the data 158, which are depicted in FIG. 1) and/or instructions (e.g., the instructions 120, the instructions 140, and/or the instructions 160, which are depicted in FIG. 1) that are stored in the one or more memory devices 116, the one or more memory devices 136, and/or the one or more memory devices 156, respectively. Additionally, the insurance data 205 can include different insurance plans from different insurance carriers (e.g., insurance providers). Each insurance plan can be associated with a tier-level and/or risk assessment score. In some instances, the insurance data 205 can be collected in real-time and uploaded to the computing system 110 or retrieved by the computing system periodically (e.g., every five minutes, every fifteen minute). In some embodiments, the insurance data 205 can be received from one or more computing systems (e.g., the remote computing system 130 depicted in FIG. 1) which can include one or more computing systems that are remote from the computing device 200.

The price data 206 can include one or more portions of data (e.g., the data 118, the data 138, and/or the data 158, which are depicted in FIG. 1) and/or instructions (e.g., the instructions 120, the instructions 140, and/or the instructions 160, which are depicted in FIG. 1) that are stored in the one or more memory devices 116, the one or more memory devices 136, and/or the one or more memory devices 156, respectively. Additionally, the price data 206 information associated with the value (e.g., price) of insurance plans. The price data 206 can include price information of current insurance plans of different insurance carriers and price information of previous (e.g., legacy, last year) insurance plans of different insurance carriers. In some embodiments, the price data 206 can be received from one or more computing systems (e.g., the remote computing system 130 depicted in FIG. 1) which can include one or more computing systems that are remote from the computing device 200.

The integration data 207 can include one or more portions of data (e.g., the data 118, the data 138, and/or the data 158, which are depicted in FIG. 1) and/or instructions (e.g., the instructions 120, the instructions 140, and/or the instructions 160, which are depicted in FIG. 1) that are stored in the one or more memory devices 116, the one or more memory devices 136, and/or the one or more memory devices 156, respectively. The integration data 207 can include configuration and/or operational information associated with integrating and synchronizing data (e.g., organizational data 203) among one or more applications or organizations that are part of the PEO. For example, the integration data 207 can include information that enables integration and synchronization between each of one or more organizations (e.g., small size business). In an embodiment, the integration data 207 provides integration information that allows an organizational data management system (e.g., a system of record for organizational data and organizational data processing), for example, to obtain information from one or more organizations or applications (e.g., third party and/or other applications), to perform operations involving organizational data (e.g., organizational data 203) in the organizational data management system, to synchronize organizational data across one or more organizations or applications, to perform one or more actions involving the organizations or applications based on organizational data in the organizational data management system, and/or to perform one or more other operations associated with managing organizational data as a system of record. In some embodiments, the integration data 207 can be received from one or more computing systems (e.g., the remote computing system 130 depicted in FIG. 1), which can include one or more computing systems that are remote from the computing device 200.

The data structures 208 can include one or more portions of data (e.g., the data 118, the data 138, and/or the data 158, which are depicted in FIG. 1) and/or instructions (e.g., the instructions 120, the instructions 140, and/or the instructions 160, which are depicted in FIG. 1) that are stored in the one or more memory devices 116, the one or more memory devices 136, and/or the one or more memory devices 156, respectively. The data structures 208 can include one or more logical and/or physical instances of information representing or describing one or more entities (e.g., objects, records, etc.), one or more relationships involving one or more of the entities, one or more data values associated with each of one or more of the entities and/or one or more of the relationships, one or more functions and/or operations that may be applied to each of one or more of the entities and/or one or more of the relationships, any other data or metadata describing or otherwise defining structure and/or rules associated with one or more of the entities and/or one or more of the relationships, etc.

The data structures 208 can be implemented and utilized with one or more types of computer software, computer hardware, or any combination thereof. In an embodiment, the data structures 208 are used to represent and perform processing associated with various types of organizational data (e.g., organizational data 203). For example, the data structures 208 may include information about various types of information and entities associated with organizational data including, but not limited to, individuals (e.g., employees, vendors, independent contractors), departments, teams, roles, groups, locations, offices, documents, tasks, reports, accounts, devices, applications, end-user applications, licenses, workflows, alerts, time information, attendance information and/or any other types of entities representing or related to managing organizational data (e.g., organizational data 203).

The data structures 208 also can define various relationships among the various entities associated with organizational data 203. For example, the data structures 208 may define and be used to enforce relationships such as each employee must be assigned to a department, each employee can be included on one or more teams, each employee must be assigned to a primary location, each employee may be assigned to one or more secondary locations, employees may have one or more computing devices, each vendor must have a current audit, each independent contractor must be associated with a contract, and/or any other relationships provided by an organizational data management system or configured for an organization that utilizes an organizational data management system (e.g., a system for managing organizational data 203 based on one or more organizational data management applications).

In some embodiments, the data structures 208 can include one or more object graphs (e.g., based on an object graph data model) providing information about entities, relationships, and/or any other aspects relating to the definition, structure, and rules associated with organizational data (e.g., organizational data 203). The data structures 208 also can include any one or more other types of data structures (e.g., with or without the use of object graphs) that provide information about entities, entity attributes, entity attribute categories, relationships, and/or any other aspects of the definition, structure, and/or rules associated with organizational data. In some embodiments, the data structures 208 can be received from one or more computing systems (e.g., the remote computing system 130 depicted in FIG. 1), which can include one or more computing systems that are remote from the computing device 200.

In some instances, the organization data 203 can include the data structures 208. In some instances, the employee data 204 can include the data structures 208 of an organization.

The application object data 210 can include one or more portions of data (e.g., the data 118, the data 138, and/or the data 158, which are depicted in FIG. 1) and/or instructions (e.g., the instructions 120, the instructions 140, and/or the instructions 160, which are depicted in FIG. 1) that are stored in the one or more memory devices 116, the one or more memory devices 136, and/or the one or more memory devices 156, respectively. Furthermore, the application object data 210 generally can include any information used to implement any particular type of application object or associated data structure that stores, references, utilizes, and/or processes data (e.g., organizational data 203). For example, such types of application objects generally may include, but are not limited to, application triggers, actions performed based on a trigger, reports, workflows, tasks, custom application objects, and/or any other types of objects used to store and/or process data in a system of record, such as an organizational data management system. Further, application object data 210 used to implement any particular type of application object or associated data structure may include, but is not limited to, instructions in a computer language (e.g., a custom computer language provided by an organizational data management system for managing organizational data 203), metadata associated with application objects or related data structures, data associated with one or more particular instances of application objects or related data structures, data associated with configuration of one or more application objects or related data structures, etc. In some embodiments, the application object data 210 can be received from one or more computing systems (e.g., the remote computing system 130 depicted in FIG. 1) which can include one or more computing systems that are remote from the computing device 200.

The one or more interconnects 212 can include one or more interconnects or buses that can be used to send and/or receive one or more signals (e.g., electronic signals) and/or data (e.g., organizational data 203, employee data 204, insurance data 205, price data 206, integration data 207, data structures 208, application object data 210, and/or any other data) between components of the computing device 200, including the one or more memory devices 202, the one or more processors 220, the network interface 222, the one or more mass storage devices 224, the one or more output devices 226, the one or more sensors 228 (e.g., a sensor array), the one or more input devices 230, and/or the one or more location devices 232. The one or more interconnects 212 can be arranged or configured in different ways. For example, the one or more interconnects 212 can be configured as parallel or serial connections. Further the one or more interconnects 212 can include one or more internal buses that are used to connect the internal components of the computing device 200 and one or more external buses used to connect the internal components of the computing device 200 to one or more external devices. By way of example, the one or more interconnects 212 can include different interfaces including Industry Standard Architecture (ISA), Extended ISA, Peripheral Components Interconnect (PCI), PCI Express, Serial AT Attachment (SATA), HyperTransport (HT), USB (Universal Serial Bus), Thunderbolt, IEEE 1394 interface (FireWire), and/or other interfaces that can be used to connect components.

The one or more processors 220 can include one or more computer processors that are configured to execute the one or more instructions stored in the one or more memory devices 202. For example, the one or more processors 220 can, for example, include one or more general purpose central processing units (CPUs), application specific integrated circuits (ASICs), and/or one or more graphics processing units (GPUs). Further, the one or more processors 220 can perform one or more actions and/or operations including one or more actions and/or operations associated with the organizational data 203, the employee data 204, the insurance data 205, the price data 206, the integration data 207, the data structures 208, the application object data 210, and/or any other data. The one or more processors 220 can include single or multiple core devices including a microprocessor, microcontroller, integrated circuit, and/or a logic device.

The network interface 222 can support network communications. The network interface 222 can support communication via networks including a local area network and/or a wide area network (e.g., the internet). For example, the network interface 222 can allow the computing device 200 to communicate with the computing system 110 via the network 102.

The one or more mass storage devices 224 (e.g., a hard disk drive and/or a solid-state drive) can be used to store data including the organizational data 203, the employee data 204, the insurance data 205, the price data 206, the integration data 207, the data structures 208, the application object data 210, and/or any other data. The one or more output devices 226 can include one or more display devices (e.g., liquid crystal display (LCD), OLED display, mini-LED display, micro-LED display, plasma display, and/or cathode ray tube (CRT) display), one or more light sources (e.g., LEDs), one or more loudspeakers, and/or one or more haptic output devices (e.g., one or more devices that are configured to generate vibratory output).

The one or more sensors 228 can be configured to detect various states and can include one or more cameras, one or more light detection and ranging (LiDAR) devices, one or more sonar devices, and/or one or more radar devices. Further, the one or more sensors 228 can be used to provide input (e.g., an image of a user captured using the one or more cameras) that can be used as part of invoking or performing one or more operations. For example, the one or more sensors 228 can be used to authenticate the identity of a user and determine an authorization level based on an image of the user's face that is captured using the one or more sensors 228.

The one or more input devices 230 can include one or more touch sensitive devices (e.g., a touch screen display), a mouse, a stylus, one or more keyboards, one or more buttons (e.g., ON/OFF buttons and/or YES/NO buttons), one or more microphones, and/or one or more cameras (e.g., cameras that are used to detect gestures that can trigger one or more operations by the computing device 200). Further, the one or more input devices 230 can be used to provide input (e.g., a rule associated with a trigger that is received from a user input of a user) that can be used as part of invoking or performing one or more operations. For example, the one or more input devices 228 can be used to receive a rule associated with a trigger for the computing system 110 to perform an action based on the activation of the trigger.

Although the one or more memory devices 202 and the one or more mass storage devices 224 are depicted separately in FIG. 2, the one or more memory devices 202 and the one or more mass storage devices 224 can be regions within the same memory module. The computing device 200 can include one or more additional processors, memory devices, and/or network interfaces, which may be provided separately or on the same chip or board. The one or more memory devices 202 and the one or more mass storage devices 224 can include one or more computer-readable media, including, but not limited to, non-transitory computer-readable media, RAM, ROM, hard drives, flash drives, and/or other memory devices.

The one or more memory devices 202 can store sets of instructions for applications including an operating system that can be associated with various software applications or data. For example, the one or more memory devices 202 can store sets of instructions for one or more applications (e.g., one or more organizational applications and/or one or more third-party applications) that are subject to one or more application policies or utilize third-party integration data that can be configured, generated, and/or implemented by the computing device 200 and/or one or more other computing devices or one or more computing systems. In some embodiments, the one or more memory devices 202 can be used to operate or execute a general-purpose operating system that operates on mobile computing devices and/or and stationary devices, including for example, smartphones, laptop computing devices, tablet computing devices, and/or desktop computers.

The software applications that can be operated or executed by the computing device 200 can include applications associated with the computing system 110, the remote computing system 130, and/or the one or more computing devices 152 that are depicted in FIG. 1. Further, the software applications that can be operated and/or executed by the computing device 200 can include native applications, web services, and/or web-based applications.

The one or more location devices 232 can include one or more devices or circuitry for determining the position of the computing device 200. For example, the one or more location devices 232 can determine an actual and/or relative position of the computing device 200 by using a satellite navigation positioning system (e.g. a GPS system, a Galileo positioning system, the Global Navigation satellite system (GLONASS), the BeiDou Satellite Navigation and Positioning system, an inertial navigation system, a dead reckoning system, based on IP address, by using triangulation and/or proximity to cellular towers or Wi-Fi hotspots, and/or beacons.

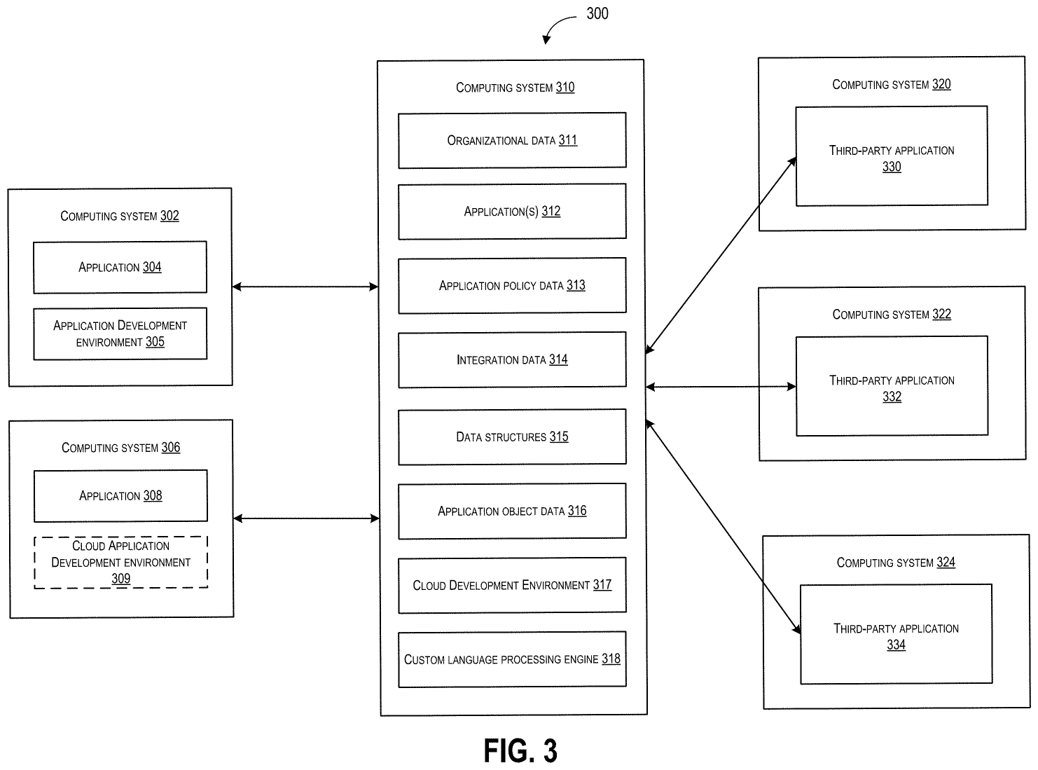

FIG. 3 depicts a block diagram of an example computing environment 300 including multiple computing systems, according to example embodiments of the present disclosure. Any of computing system 302, computing system 306, computing system 310, computing system 320, computing system 322, or computing system 324 can include one or more attributes and/or capabilities of the computing system 110, the remote computing system 130, the one or more computing devices 152, and/or the computing device 200. Furthermore, any of the computing system 302, the computing system 306, the computing system 310, the computing system 320, the computing system 322, or the computing system 324 can be configured to perform one or more operations and/or one or more actions that can be performed by the computing system 110, the remote computing system 130, the one or more computing devices 152, and/or the computing device 200.

As shown in FIG. 3, the environment 300 includes the computing system 302, an application 304, an application development environment 305, the computing system 306, an application 308, a cloud application development environment 309, the computing system 310, organizational data 311 (e.g., organizational data 203), one or more application(s) 312, application policy data 313, integration data 314, data structures 315, application object data 316, cloud development environment 317, custom language processing engine 318, computing systems 320, 322, 324, and third-party applications 330, 332, 334.

In an embodiment, the computing system 302, the computing system 306, the computing system 310, the computing system 320, the computing system 322, and/or the computing system(s) 324 can be configured to communicate directly and/or via a communication network (e.g., the network 102 depicted in FIG. 1). In some instances, the computing system 302 can be associated with the first organization of the PEO, the computing system 306 can be associated with a second organization of the PEO, the computing system 320 can be associated with a third organization of the PEO, and so on.

In one embodiment, the computing system 302 includes an application 304 that is stored and/or operates on the computing system 302 and can communicate (e.g., send and/or receive data and/or information) with one or more other computing systems including the computing system 306 and/or the computing system 310. The application 304 can, for example, include an application that performs one or more operations on the computing system 302 associated with an organizational record that is stored as part of the organizational data 311. In an example, a user associated with any computing system 302, 306, 310 can use a portion of the organizational data 311 associated with their employee record to access a corresponding account associated with one or more of application 304, application 308, and/or application(s) 312.

In an embodiment, one or more application(s) 312 provide access to, utilize, support, and/or otherwise provide various interfaces or services that enable other applications (e.g., application 304, application development environment 305, application 308, cloud application development environment 309, application(s) 312) and/or users to perform various operations and activities involving one or more custom computer languages. For example, a custom computer language (e.g., a custom query language) generally may provide users with a simplified set of computer instructions that align with or match a user's understanding of a functional or business environment, such as an organization, business, industry, sector, etc. In some embodiments, each of one or more custom computer languages is a user language that allows users with a basic understanding of a subject, topic, business area, organization, functional role, industry, sector, etc. to implement custom computer instructions in terms that are familiar to the users, without knowledge of a complex computer programming language, without dependence on computer programmers, without being aware of or needing to know the complexity of underlying data organization and storage, without needing to understand, implement, and/or maintain a complex web of join conditions across various sets of underlying data, etc.

In an embodiment, a custom computer language generally enables users of any skill or level with a basic knowledge of a subject area to perform one or more operations or activities associated with an application (e.g., any of applications 312). For example, a custom computer language generally may enable a user to create, update, execute, and/or otherwise implement custom queries, reports, policies, workflows, triggers, and/or other functionality and operations associated with an application. In some embodiments, a custom computer language enables a user to utilize and perform various operations involving organizational data 311. For example, one or more applications associated with an organizational data management system or any other types of applications (e.g., applications 312) generally may provide a custom computer language allowing users to perform operations based on the structure and/or relationships associated with organizational data 311.

In an embodiment, a custom computer language may allow a user to use simplified terms to query organizational data 311. In one example, a custom computer language may allow a user to obtain the name of an employee's manager with the following example query: “ORG(John Smith, Manager)”, which may return “Jane Jones” as the manager of the employee. As such, a custom computer language for an application may allow a user to use simplified and familiar terms without needing to understand complex interrelationships between various types of data stored across one or more different databases and/or other types of data stores. Further, a custom computer language generally may be processed by one or more applications (e.g., application(s) 312 associated with an organizational data store) so that users do not have to specify data joins when performing various operations involving organizational data 311.

In an embodiment, a custom computer language is based on and/or otherwise associated with one or more data structures 315 associated with an application. For example, a custom computer language may be based on, represent, describe, or otherwise be associated with an object graph data structure 315 (e.g., a master object graph, any one or more portions of a master object graph, etc.) and/or any other types of data structures 315 that describe the structure of an application and/or the underlying data associated with an application. In an example, a custom computer language is based on the structure of one or more applications and/or associated organizational data 311 of an organizational data management system. For example, the structure of the one or more applications and/or the associated organizational data 311 may be represented and described in one or more data structures 315 including, but not limited to, one or more independent and/or interrelated object graph data structures 315. In various embodiments, an application (e.g., one of application 312) and/or another supporting application used in association with the application can utilize object graph data structures 315 to process and perform various underlying operations associated with custom computer language instructions.

In an embodiment, the computing system 302 includes an application development environment 305 that provides users with access to and/or operations associated with one or more computer languages including, but not limited to, a custom computer language. For example, the application development environment 305 can be associated with one or more applications of an organizational data management system that stores and manages various types of organizational data 311. In an example, application development environment 305 generally may be an application (e.g., application 304) or portion of an application that enables a user to perform various operations involving organizational data 311 of an organizational data management system using a custom computer language. For example, application development environment 305 generally may enable a user to create, update, execute, and/or otherwise implement custom rules associated with triggers, actions performed based on an activation of a trigger, and/or other functionality and operations associated with one or more applications of an organizational data management system.

In various embodiments, any one or more parts of the application development environment 305 may run, for example, on a computing system (e.g., computing system 302) and/or in association with information, applications, and/or services on another computing system (e.g., computing system 310). For example, application development environment 305 may utilize organizational data 311, application(s) 312, application policy data 313, integration data 314, data structures 315, and/or application object data 316 available from another computing system (e.g., computing system 310, one or more computing systems associated with an organizational data management system, etc.). Application development environment 305 also may include a query processing engine (not shown), computer instruction compiler (not shown), computer instruction generator (not shown), and/or other specialized computer software for performing operations associated with providing triggers in a system of record (e.g., based on computer instructions in a custom computer language provided by the system of record). Application development environment 305 also may utilize or work in conjunction with, in whole or in part, cloud development environment 317 and custom language processing engine 318 (including, for example any computer instruction compiler (not shown) and/or computer instruction generator (not shown) associated with custom language processing engine 318), and/or other features and or operations available from another computing system (e.g., computing system 310, one or more computing systems associated with an organizational data management system, etc.).

In an embodiment, application development environment 305 can include a user interface (e.g., an editor) that allows users to enter, define, edit, check, store, schedule, execute, and/or perform any other operations associated with creating, viewing, maintaining, and/or utilizing computer instructions in a custom computer language. In some embodiments, application development environment 305 includes a textual editor that enables users to enter and manipulate computing instructions in a custom computer language. In some examples, a textual editor of the application development environment 305 may assist users with constructing various types of statements in a custom computer language. For example, the textual editor may provide syntax highlighting in a custom computer language, intelligent completion of keywords or statements in a custom computer language, automated hints and examples, various types of pop-up information to assist a user in writing or editing instructions in a custom language, visual notification of syntax or other errors, suggested correction of syntax or other errors, automatic suggestion and/or population of objects and/or functions, etc. In some examples, automation and other assistance provided by a textual editor of the application development environment 305 may be based on and may actively utilize one or more data structures 315 (e.g., an object graph based on organizational data 311) associated with implementation of a custom computer language.

In an embodiment, the computing system 310 includes one or more application(s) 312 that can perform one or more operations on the computing system 310 and can communicate data and/or information with any one or more computing systems, including the computing system 302 and/or the computing system 306, or any one or more computing devices. The application(s) 312 can, for example, include an employee management application that operates on the computing system 310 and accesses the organizational data 311, which can include one or more organizational records associated with the names of organization employees and the respective employment status for each of the employees (e.g., an employee's position or role within the organization, an organizational department associated with the employee, etc.). A user (e.g., a privileged user, such as a manager or administrator with the authority to access and/or modify the organizational data 311) associated with the computing system 306 can, for example, access and/or modify the organizational data 311 to reflect when an employee receives a promotion or a raise, changes to a different department, is added to one or more new teams, is assigned new computer hardware or other equipment, etc.

The one or more application(s) 312 can perform one or more operations on the computing system 310 and can communicate data and/or information with one or more computing systems, including the computing system 302 and/or the computing system 306, or any one or more computing devices. The application(s) 312 can, for example, include an administrative or other type of system application to manage one or more aspects of the application(s) 312 including, but not limited to, installing, configuring, maintaining, updating, integrating, automating and/or performing one or more other operations associated with the application(s) 312 on the computing system 310 and that can manage one or more aspects of one or more other applications on different systems and devices, which may include the application 304 and/or the application 308.

In some embodiments, the application(s) 312 can include one or more third-party applications that are stored and/or perform operations on the computing system 310. Further, the application(s) 312 can retrieve data and/or information associated with and/or operate in cooperation with applications external to the computing system 310 (e.g., the computing system 302 and/or the computing system 306). The application(s) 312 can also use (e.g., access, modify, and/or control) the organizational data 311. For example, the application(s) 312 can use the organizational data 311 that is associated with the application 304 to perform one or more operations using the application 308 that is on the computing system 306.

In an embodiment, the computing system 306 includes a cloud application development environment 309. For example, the cloud application development environment 309 generally may be a local instance of an online integrated development environment (e.g., a cloud development environment 317) provided by one computing system (e.g., computing system 310) that is accessed from a web browser and/or any other type of application 308 on another computing system (e.g., computing system 306). For example, the cloud application development environment 309 can be associated with one or more applications of an organizational data management system that stores and manages various types of organizational data 311. In an example, cloud application development environment 309 generally may be an application (e.g., application 308) or portion of an application that enables a user to perform various operations involving organizational data 311 of an organizational data management system using a custom computer language. For example, cloud application development environment 309 generally may enable a user to create, update, execute, and/or otherwise implement custom queries, reports, policies, workflows, triggers, rules, group assignments, and/or other functionality and operations associated with one or more applications of an organizational data management system.

In various embodiments, any one or more parts of the cloud application development environment 309 may run, for example, on a computing system (e.g., computing system 306) and/or in association with information, applications, and/or services on another computing system (e.g., computing system 310). For example, cloud application development environment 309 may utilize organizational data 311, application(s) 312, application policy data 313, integration data 314, data structures 315 and/or application object data 316 available from another computing system (e.g., computing system 310, one or more computing systems associated with an organizational data management system, etc.). Cloud application development environment 309 also may include a query processing engine (not shown), computer instruction compiler (not shown), computer instruction generator (not shown), and/or other specialized computer software for performing operations associated with providing triggers in a system of record (e.g., based on computer instructions in a custom computer language provided by the system of record). Cloud application development environment 309 also may utilize or work in conjunction with, in whole or in part, cloud development environment 317 and custom language processing engine 318 (including, for example any computer instruction compiler (not shown) and/or computer instruction generator (not shown) associated with custom language processing engine 318), and/or other features and or operations available from another computing system (e.g., computing system 310, one or more computing systems associated with an organizational data management system, etc.).

In an embodiment, cloud application development environment 309 can include an editor that allows users to enter, define, edit, check, store, schedule, execute, and/or perform any other operations associated with creating, viewing, maintaining, and/or utilizing computer instructions in a custom computer language. In some embodiments, cloud application development environment 309 includes a textual editor that enables users to enter and manipulate computing instructions in a custom computer language. In some examples, a textual editor of the cloud application development environment 309 may assist users with constructing various types of statements in a custom computer language. For example, the textual editor may provide syntax highlighting in a custom computer language, intelligent completion of keywords or statements in a custom computer language, automated hints and examples, various types of pop-up information to assist a user in writing or editing instructions in a custom language, visual notification of syntax or other errors, suggested correction of syntax or other errors, automatic suggestion and/or population of objects and/or functions, etc. In some examples, automation and other assistance provided by a textual editor of the cloud application development environment 309 may be based on and may actively utilize one or more data structures 315 (e.g., an object graph based on organizational data 311) associated with implementation of a custom computer language.

In an embodiment, cloud application development environment 309 can include a visual editor (e.g., either with or without a textual editor) to, for example, create, view, maintain, and/or utilize computer instructions in a custom computer language. For example, the visual editor may allow users to build, modify, and perform other operations associated with instructions in a custom computer language via a drag and drop and/or any other types of graphical user interfaces (e.g., a software wizard or setup assistant user interface that presents a user with a sequence of dialog boxes or other types of interfaces that guide the user through a series of steps in generating one or more portions of an application). Further, a visual editor generally also may provide dropdown lists, enhanced browsing, and other visual access to features and operations of a custom computer language, and/or one or more data structures 315 associated with a custom computer language or related application to construct, edit, and/or otherwise utilize instructions in a custom computer language. In some examples, the cloud application development environment 309 may provide a textual editor in combination with the visual editor to allow users to view, utilize, and alternate between both textual and visual editors of a custom query language, for example, as part of the same user interface.

The computing system 310 includes the application policy data 313 which can be implemented on the computing system 310 and can be used to perform one or more operations associated with implementing an application policy associated with the organizational data 311 and/or one or more applications including the application 304, the application 308, and/or application(s) 312. The application 304, the application 308, and/or application(s) 312 can include one or more third-party applications that are separate from, that are operated separate and apart from, and that are not affiliated with the organization that manages, owns, controls and/or maintains the organizational data 311 or an associated organizational data management application on the computing system 310, and/or that determines or implements an application policy associated with the application policy data 313. In one example, third-party applications can be differentiated from organizational applications that, for example, are inherent to, are a part of, or otherwise operate directly or as part of an organizational data management application, system, services, and/or platform.

The application policy data 313 can include one or more rules that determine how one or more applications including, for example, one or more third-party applications or organizational applications are accessed, modified, and/or controlled. For example, the application policy data 313 can use the organizational data 311 that is associated with the application 304 to perform one or more operations on the application(s) 312 and/or the application 308. Also, the application policy data 313 can use the organizational data 311 that is associated with the application(s) 312 to perform one or more operations on the application 304 and/or the application 308. By way of further example, the application policy data 313 can use the organizational data 311 that is associated with the application 308 to perform one or more operations on the application 304 and/or the application(s) 312. In some embodiments, the application policy data 313 can determine how a combination of one or more organizational applications (e.g., applications owned and controlled by an organization that owns and controls the organizational data 311 and/or applications provided with or as part of an organizational data management system used by the organization as a system of record for maintaining the organizational data 311, etc.) and/or one or more third-party applications are accessed, modified, configured, and/or controlled.

The computing system 310 includes the integration data 314, which can reside on the computing system 310 and can be used, for example, to perform one or more operations that integrate the organizational data 311 and associated activities based on the organizational data 311 across one or more different computing systems (e.g., such as computing systems 302, 306, and 310) and/or applications (e.g., such as applications 304, 308, and 312). For example, the integration data 314 can be used to integrate and synchronize organizational data 311 and/or associated operations across an organizational data management application or system (e.g., a system of record for organization data 311) and each of one or more separate third-party applications that utilize organizational data 311 and/or perform operations based on organizational data 311.

In an embodiment, the integration data 314 can include configuration information associated with integrating and synchronizing data among one or more computing systems and/or applications. For example, the integration data 314 can include information that enables integration between an organizational application (e.g., an application 312 associated with an organizational data management system of record for the organizational data 311) and each of one or more separate third-party applications (e.g., application 304, application 308, etc.) that use or perform operations based on the organizational data 311). Such integration data 314 may include, but is not limited to, information indicating and/or describing various data that enables performance of an integration between applications or systems, such as an integration type information (e.g., flat file, application programming interface or “API”, webhook, system call, etc.), security information (authentication information, encryption information, etc.) technical information (e.g., file locations, call information, system naming, application naming, IP address information, port information, etc.), integration flow information (e.g., push, pull, bidirectional, etc.), integration activation (e.g., scheduling or timing information, event information, one or more rules, one or more triggers or criteria, etc.), processing information (e.g., data mappings between the source and target, data validation rules, data transformations, error handling, etc.), and/or any other information used in defining, configuring, and/or integrating an application with each of any number of third-party applications and/or systems.

The computing system 310 includes the data structures 315, which can be implemented on the computing system 310 and used to perform operations involving the organizational data 311 including, but not limited to, performing integration and synchronization of the organizational data 311 with one or more different third-party applications and/or systems, generating and processing computer instructions across one or more different systems based on the organizational data 311, etc. In an embodiment, the data structures 315 generally can include information about the properties or attributes of each of one or more entities associated with the organizational data 311. Data structures 315 also can include information describing relationships associated with one or more entities associated with the organizational data 311 (e.g., explicit relationships defined between entities, virtual relationships determined based on various attributes and data associated with entities, etc.). In some embodiments, the data structures 315 generally can be used in validating and processing the organizational data 311 and/or other information received from third-party applications and/or systems. The data structures 315 also can be used in association with performing or otherwise carrying out one or more operations involving the organizational data 311 including, but not limited to, processing requests, validating queries, generating computer instructions, processing computer instructions, generating workflows, executing workflows, generating triggers, evaluating trigger conditions, performing trigger operations, creating reports, running reports, etc.

In an embodiment, the data structures 315 can include one or more object graphs and/or any other types of data structures that provide information about entities, relationships, rules, constraints, and/or any other aspects of managing the organizational data 311. For example, such object graphs can include one or more nodes representing entities associated with the organizational data 311 and one or more edges that connect and represent relationships between the nodes (e.g., explicit edges defining relationships between entities and data, virtual edges inferring relationships between entities and data, etc.). The data structures 315 can also include organizational data and/or associated metadata. In addition, the data structures 315, together or alone, generally may represent one or more structural aspects of an application or system (e.g., such as an organizational data management system that is a system of record for organizational data 311 of an organization). In various examples, the data structures 315 generally may be used to support various operations performed by a system of record including but not limited to performing one or more operations for providing triggers in the system of record. For example, the data structures 315 alone or in combination with configuration data and/or one or more types of information) may be used to generate new instructions in a computer language, which may include a custom computer language provided to users. Further, such new instructions generally may include one or more operations (e.g., one or more underlying data joins) that are identified and included in the generated instructions based on analyzing instructions received in the custom computer language in view of the data structures 315.

The computing system 310 includes the application object data 316, which can be implemented on the computing system 310. For example, the application object data 316 can include any information that is used to implement any type of application object or data structure for an application object that may store, reference, utilize, and/or process data. In an example, a system of record generally may support application objects that include, but are not limited to, application triggers, application reports, application workflows, application tasks, custom objects, and/or any other types of objects.

In an embodiment, application triggers generally may include application objects that are referenced based on an event. For example, an application trigger may be referenced based on one or more internal application or system events (e.g., occurring within a system of record, etc.), based on one or more external application or system events (e.g., occurring outside of a system of record, occurring in a third-party application integrated with a system of record, etc.), or based on a combination of one or more internal application or system events and one or more external application or system events.

Generally, an application trigger may include one or more conditions to be evaluated when the application trigger is referenced by an application or system. For example, such conditions may include, but are not limited to, conditional statements that test one or more aspects of organizational data 311. In one example, when the application trigger is referenced and the conditions of the application trigger are satisfied (e.g., evaluate to true), then one or more operations associated with the trigger are automatically executed. For example, the one or more operations associated with the application trigger may cause an application or system to perform one or more operations internally, may cause the application or system to perform one or more operations in association with an external application or system (e.g., based on an integration, etc.), or may cause the application or system to perform one or more operations internally and to perform one or more operations with an external application or system.

In an embodiment, application reports generally may include any computer instructions that are executed by an application or system to obtain a collection of data or the resulting collection of data. Application workflows generally may refer to an object or objects that define a sequence of steps for automating a process associated with an application or system. Application tasks generally may be objects that are used to define one or more actions or pieces of work to be performed by a user or group of users. Application tasks may be assigned or delegated to one or more users or groups of users. Application tasks also may include information related to a particular task (e.g., start date, due date, etc.). Applications and systems may allow a user of an organization to create custom objects, which may define one or more custom object attributes, custom object operations, and relationships with entities provided by an application or system and/or other custom objects defined for an organization.

The computing system 310 includes the cloud development environment 317, which can be implemented on the computing system 310, for example, to provide users with access to an environment for writing, building, testing, executing, and/or performing any other types of operations involving instructions in a custom computer language. In an embodiment, the cloud development environment 317 may include and/or perform operations associated with the custom language processing engine 318 and, for example, any computer instruction compiler (not shown) and/or any computer instruction generator (not shown) associated with custom language processing engine 318. In addition, the cloud development environment 317 may run on one computing system (e.g., computing system 310) and provide one or more services to applications running on another computing system (e.g., application development environment 305 on computing system 302, cloud application development environment 309 on computing system 306, etc.). Further, the cloud development environment 317 may perform any one or more of the operations previously described with respect to application development environment 305 and/or cloud application development environment 309. Similarly, application development environment 305 and/or cloud application development environment 309 may perform any one or more of the operations described in association with cloud development environment 317.

The computing system 310 includes the custom language processing engine 318, which can be implemented on the computing system 310 and used to perform operations associated with processing requests based on instructions in a custom computer language. In various embodiments, the custom language processing engine 318 may receive requests for processing that include one or more instructions in a custom computer language. For example, such requests may be received from one or more different computing systems (e.g., computing system 302, computing system 306, computing system 310, etc.) and/or one or more different applications (e.g., application 304, application development environment 305, application 308, cloud application development environment 309, application(s) 312, cloud development environment 317, etc.). Custom language processing engine 318 may be associated with or utilize one or more computer instruction compilers (not shown) and/or one or more computer instruction generators (not shown), which for example, may be separate, part of, or integrated with the custom language processing engine 318.

In an embodiment, a computer instruction compiler of the custom language processing engine 318, can be implemented on the computing system 310 and used to perform operations associated with analyzing instructions in a custom computer language including, but not limited to, parsing and analyzing custom computer language instructions based on one or more rules associated with a custom computer language and/or associated data structures 315, for example, to determine whether any error exists in the custom computer language instructions, to identify one or more errors in the custom computer language instructions, to return information about one or more of the identified errors, to determine when the custom computer language instructions are free from error, etc. The computer instruction compiler of the custom language processing engine 318 may include or be associated with a computer instruction generator (not shown) that generates one or more new instructions in a computer language, such as a custom computer language.

In an embodiment, a computer instruction generator of the custom language processing engine 318, can be implemented on the computing system 310 and used to generate one or more new instructions in a custom computer language. For example, the computer instruction generator may generate instructions in a custom computer language for execution based on configuration of one or more application objects and/or data associated with such application objects (e.g., application triggers, application reports, application workflows, application tasks, custom objects, etc.). In one example, such instructions in the custom computer language may be executed by an application of a system of record to perform one or more operations involving the system of record and/or any third-party application integrated with the system of record. In one example, the computer instruction generator may generate instructions in any computer language, for example, to be executed in association with any application or computing system. For example, the computer instruction generator may generate instructions in a different computer language for execution with one or more other applications 312 or data stores (not shown) on or associated with computing system 310 and/or one or more other applications (e.g., application 304, application 308, third-party application 330, third-party application 332, third-party application 334) associated with other computing systems (e.g., computing system 302, computing system 306, computing system 320, computing system 322, computing system 324).

In various examples, third-party applications (e.g., third-party application 330, third-party application 332, third-party application 334) generally may be any type of computer application referenced within the present disclosure or otherwise available. In some examples, each third-party application may be associated with a respective computing system (e.g., computing system 320, computing system 322, computing system 324). In some examples, each third-party application may be associated with one or more different computing systems. In some examples, multiple third-party applications may run on each of one or more different computing systems.

In an embodiment, an application store computing system (not shown) provides an organization with access to multiple different integration applications (not shown) for integrating organizational data 311 and/or associated processes with and across various different applications and/or systems (e.g., application(s) 312, third-party application 330, third-party application 332, third-party application 334, etc.). An application store computing system also may provide an organization with one or more other types of applications, including but not limited to, platform utility apps that provide additional functionality to an organizational data management application or system, other apps that may include integration-related applications, and/or any other types of applications. Generally, the application store computing system may provide one or more various applications for a flat fee, based on a subscription purchase, for a fee based on usage, for a fee based on a number of users, computing systems, processors, or any other criteria, as part of a limited trial, for free, and/or generally under any type of arrangement. In an embodiment the application store computing system is managed and provided by the same party that provides an organizational data management system to organizations. For example, the integration applications provided by the application store computing system generally may be specialized for use with the organizational data management system (e.g., and not end-user versions of applications that would be installed for general purpose use by end-users on end-user devices or for use by end-users via cloud services or any other types of services).

In an embodiment, the integration applications generally can be any application that allows an organization to manage any one or more aspects associated with providing one or more corresponding end-user applications to individual members (e.g., employees), teams, roles, departments, and/or any other grouping or categorization of individuals in an organization. For example, each of the integration applications can be used by an organization to control and automate various tasks associated with provisioning, configuring, maintaining, and integrating third-party applications. In some embodiments, one or more of the integration applications can allow an organization to configure automated assignment of a corresponding end-user application to one or more individuals, user account creation, single sign-on setup, provisioning, installation, setup, and/or maintenance of corresponding end-user applications (e.g., third-party applications or other applications available for use by end users) provided to particular individuals, groups, and/or one or more devices associated with such individuals or groups in the organization (e.g., via installation on respective user devices, via a cloud application service available to end users, etc.).

In an embodiment, one or more of the integration applications can provide integration of organizational data 311 and associated services with one or more corresponding third-party applications (e.g., application 304 on computing system 302, application 308 on computing system 306, application(s) 312 on computing system 310, third-party application 330 on computing system 320, third-party application 332 on computing system 322, third-party application 334 on computing system 324, etc.) that utilize and/or perform operations based on organizational data 311. For example, each of the integration applications can provide one or more of user account creation, single sign-on integration, user account suspension or removal, user management, group management, user privileges, user data access, user data control, template management, data integration, process automation, and/or any other types of integration between applications (e.g., third-party applications or other applications) that are associated with organizational data 311 of an organization.

In an embodiment, the integration applications and/or other applications provided by the application store computing system may include, but are not limited to, collaboration apps, support apps, design apps, development apps, finance and legal apps, human resources (HR) and benefits apps, information technology (IT), device management, and security apps, office management apps, sales and marketing apps, charitable apps, platform utility apps, and/or other apps. Generally, various different types of applications provided by the application computing system may be organized, categorized, grouped, presented, and/or otherwise offered in any type of arrangement, and thus are not limited to any particular examples discussed herein, which are provided for illustration purposes only.

In an embodiment, collaboration apps may include, for example, any applications that provide scheduling, communications, document sharing and management, electronic signature services, project management, productivity, and/or any other types of applications that facilitate work between individuals, groups, and/or parties.

In an embodiment, support apps may include, for example, any applications that provide services associated with customer support, technical support, issue reporting, issue management and escalation, tracking and managing help desk tickets, and/or any other types of applications that facilitate customer, business, and/or technology support.

In an embodiment, design apps may include, for example, any applications that provide services associated with creating graphic designs, product designs, prototypes, drawings, graphical user interfaces, user experiences, and/or any other types of applications that facilitate the creation of designs, interfaces, and/or artistic works.

In an embodiment, development apps may include, for example, any applications that provide services associated with software development, software testing, source code control and management, source code scanning, application testing, process automation, cloud hosting and services, system monitoring, error reporting and alerts, machine learning, and/or any other types of applications that facilitate activities associated with building, maintaining, or deploying software applications.

In an embodiment, finance, operational, and legal apps may include, for example, any applications that provide services associated with accounting systems, budgeting systems, vendor management systems, payment systems, travel systems, expense management systems, supply chain systems, manufacturing systems, compliance and governance systems, vendor management systems, contract management systems, and/or any other types of applications and/or systems used to manage various aspects of an organization.

In an embodiment, human resources (HR) and benefits apps may include, for example, any applications that provide services associated with recruiting and hiring, temporary staffing, background checks, payroll and benefits, training and onboarding, retirement planning and contributions, reward and bonus programs, employee training, learning management systems, performance management, insurance, and/or systems any other types of applications or systems associated with employee-related activities.

In an embodiment, information technology (IT), device management, and security apps may include, for example, any applications that provide services associated with device management, technology, information security, password management, and/or any activities associated with managing applications, systems, devices, or associated technology.

In an embodiment, office management apps may include, for example, any applications that provide services associated with facilities management, receptionist services, physical access, visitor access, catering services, office layout, office assignments, and or any other types of applications or systems associated with performing office management.

In an embodiment, sales and marketing apps may include, for example, any applications that provide services associated with social media, analytics, advertising, event management, customer relationship management, content creation and distribution, public relations, business generation, campaign management, and/or any other types of similar or related activities.

In an embodiment, charitable apps may include, for example, any applications that provide services associated with donations, charitable giving, crowdfunding, etc.

In an embodiment, platform utility apps may include, for example, any applications from a provider that allow an organization to utilize software applications, systems, or services that have been purchased or that are otherwise available from the provider. For example, a provider of an organizational data management system can allow an organization to access and utilize standard services and/or enhanced services via one or more of the platform utility apps. In some embodiments, the platform utility apps operate from and/or are directly integrated with applications, systems, and/or services obtained from a provider. For example, such platform utility apps can allow one or more users of an organization to customize a particular implementation or instance of provider software that is associated with the organization. In one example, one of the platform utility apps can allow the creation and/or modification of one or more custom fields in association with one or more entities, the creation and/or modification of one or more relationships among the entities, the creation and/or modification of one or more default system rules or custom rules, the addition and/or use of custom fields, custom relationships and/or custom rules in various workflows, triggers, tasks, reports, integrations, etc. In some embodiments, users may create and modify custom fields, relationships, rules, tables, entities, and any other various aspects of an organizational data management system in a utility application or otherwise using a custom computer language provided by the organizational data management system.

In an embodiment, other apps may include, for example, any types of applications that may be used by individuals and/or organizations. The other apps may include, for example, any other category of integration applications and/or any other types of applications that can be executed by a computing system or device.

In an embodiment, authorized users of an organization with the appropriate privileges may access one or more services of the application store computing system directly, for example, via a website, web page, desktop application, mobile application, and/or any other type of application to browse, view, search, compare, evaluate, download, install, configure, upgrade, uninstall, and/or perform any other types of activities associated with the integration applications or any other types of applications provided via the application store computing system. In some embodiments, authorized users of an organization with the appropriate privileges may access one or more services of the application store computing system indirectly, for example, through another application (e.g., application 312) and/or another computing system (e.g., computing system 310). In some embodiments, the application store computing system can be provided on the same computing system with other applications and services (e.g., running on computing system 310).

In an embodiment, any one or more users of an organization, such as an administrator, manager, or one or more other users associated with a particular role and/or one or more particular privileges each may install and/or configure each of one or more different integration applications for use by the organization. For example, any such user with the appropriate privileges may install one or more of the integration applications for the organization on the computing system 310 or any other computing systems or devices. Also, any such user with the appropriate privileges may configure integration data 314 associated with each of one or more integration applications. In some embodiments, one user with the appropriate privileges may delegate authority to one or more other users to perform installation and/or configuration of one or more of the integration applications for an organization.

In an embodiment, an organizational data management system is provided via at least one computing system to allow each of one or more different organizations to centrally manage their own organizational data 311. For example, the organizational data management system can be provided as a centralized system of record for storing and managing various types of organizational data 311 of an organization. The organizational data management system also can provide various types of integration across different third-party applications that utilize, that perform processing involving or based on, and/or that are otherwise associated with organizational data 311. The organizational data management system also can automate various processing based on the organizational data 311 including, but not limited to the automation of processing performed across various third-party applications based on the organizational data 311. In various embodiments, the organizational data management system can be provided via one or more different computing systems, one or more different applications, and/or via one or more different services, for example, to one or more different organizations over a computer network.

In an embodiment, a separate instance of an organizational data management system generally can be provided to each of one or more different organizations, for example, to allow each organization to independently configure, manage, and integrate their own instance of an organizational data management system, and to secure and insulate organizational data 311 from outside parties. For example, separate instances of an organizational data management system generally may be provided to different organizations using different computer hardware devices, different software applications, different instances of software applications running in an isolated space, different databases, physically partitioned databases, and/or in various other ways.

In an embodiment, an organizational data management system generally enables organizations to efficiently manage organizational data 311 and associated processing that occurs based on the organizational data 311. For example, an organizational data management system may be used as a centralized system of record that is integrated with other computing systems and applications (e.g., third-party applications 330, 332, 334) that generate, utilize, process, and/or perform activities based on organizational data 311. Such integration generally allows an organizational data management system to orchestrate and automate processing of organizational data 311 and associated activities across numerous different applications that are not in communication or coordination with one another. In some embodiments, an organizational data management system can allow appropriate users (e.g., authenticated, authorized, privileged, etc.) of an organization to, for example, manage organization information, settings of an organizational data management system, onboarding of employees, offboarding of employees, employee information, organizational structure and locations, employee placement in departments and teams, workflows and tasks, reports, documents, and/or any other information associated with organizational data 311.

In an embodiment, an organization uses an organizational data management system that allows the organization to manage organizational data 311 and activities performed based on the organizational data 311. In some embodiments, an organization can install and use an organizational data management system on a computing system (e.g., computing system 310 or any other computing system) that is dedicated to the organization. Also, an organizational data management system can comprise any one or more of organizational data 311, application(s) 312, application policy data 313, integration data 314, data structures 315, application object data 316, cloud development environment 317, custom language processing engine 318, and/or any other information associated with managing, processing, and performing activities associated with organizational data 311. In addition, an organizational data management system may provide and utilize its own custom computer language that allows business users to access and perform various operations using simplified computer instructions based on structure of organizational data 311. Further, an organizational data management system may provide various features and user interfaces to configure and to automate the execution of triggers in the custom computer language to perform various activities within the organizational data management system and across one or more other applications (e.g., third-party application 330, third-party application 332, third-party application 334) running on one or more different computing systems (e.g., computing system 320, computing system 322, computing system 324).

In an embodiment, an organizational data management system may be provided by another party for use by an organization. For example, another party such as a software application provider may host or otherwise provide a separate instance of an organizational data management system to each of one or more different organizations allowing each organization to independently manage their own organizational data 311. In such embodiments, each separate instance of an organizational data management system provided to an organization can respectively comprise any one or more of organizational data 311, application(s) 312, application policy data 313, integration data 314, data structures 315, application object data 316, and/or any other information associated with managing, processing, and performing activities associated with organizational data 311 for the particular organization. As such, an organizational data management system may be a cloud-based platform that maintains organizational data 311 and other information associated with each of one or more different organizations and that allows each of the different organizations to independently manage their own respective organizational data 311 and related processes independently from any other organization.

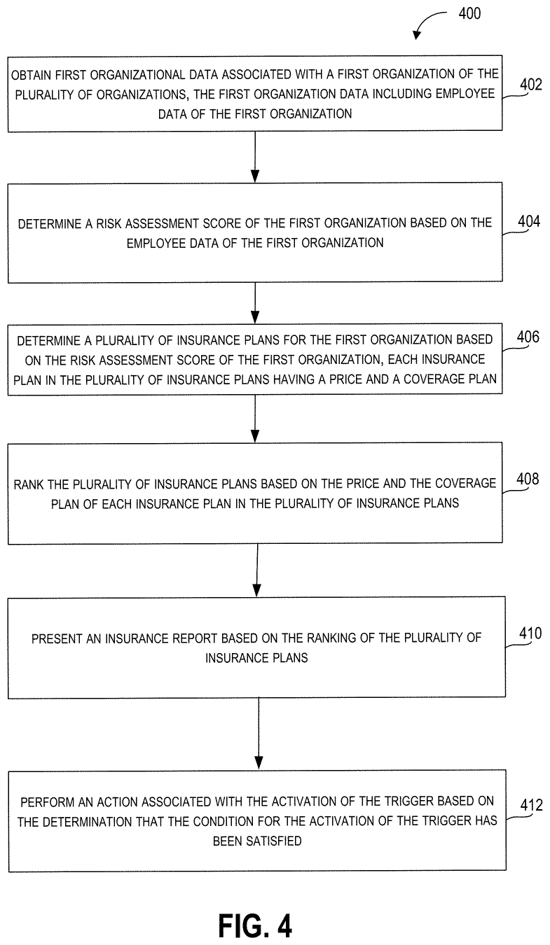

FIG. 4 depicts a flow diagram of an example method 400 for generating an insurance report in a system that manages organizational data, according to example embodiments of the present disclosure. One or more portions of the method 400 can be executed and/or implemented on one or more computing devices or computing systems including, for example, the computing system 110, the remote computing system 130, the one or more computing devices 152, the computing device 200, the computing system 302, the computing system 306, and/or the computing system 310. In addition, one or more portions of the method 400 can be executed or implemented as an algorithm on the hardware devices or systems disclosed herein. FIG. 4 depicts steps performed in a particular order for purposes of illustration and discussion. As such, those of ordinary skill in the art, using the disclosures provided herein, will understand that various steps of any of the methods disclosed herein can be adapted, modified, rearranged, omitted, and/or expanded without deviating from the scope of the present disclosure.

According to some embodiments, the computing system of method 400 can implement an organizational management platform to manage applications (e.g., application 304, application 308) for an organization. The computing system can include one or more databases (e.g., one or more memory devices 116, one or more memory devices 136, one or more memory device 156, one or more memory devices 202) that collectively store organizational data (e.g., data 118, data 138, data 158, organizational data 203, organizational data 311) associated with the organization. The organizational data can include an object graph data structure comprising a plurality of data objects associated with the organizational data.

In some instances, the computer system can include one or more processors, one or more databases, and one or more memory devices. The one or more databases can store organizational data associated with a plurality of organizations. The plurality of organizations can be part of a professional employer organization (PEO). The one or more memory devices can store instructions that, when executed by the one or more processors, cause the computer system to perform operations described in method 400.

At 402, the computer system can obtain the first organizational data associated with a first organization of the plurality of organizations. The computer system at 402 can be an example of the management system described herein. The first organization data (e.g., organizational data 203, organizational data 311) can include employee data (e.g., employee data 204) of the first organization. The employee data can include the number of employees at the first organization, the age of the employees, the gender of the employees, and other relevant information that an insurance carrier may require in order to provide insurance coverage for the employees of the first organization. The employee data can also include health data including but not limited to nutrition information, fitness information, health condition, and biometric information such as blood pressure and cholesterol.

At 404, the computer system can determine a risk assessment score of the first organization based on the employee data of the first organization. In some instances, the risk assessment score can be calculated for each employee of the first organization based on a machine-learned algorithm that incorporates information on the employee's age, health condition during the previous year, and other factors. Alternatively, the risk assessment score can be calculated for the whole organization (e.g., first organization) using a machine-learned algorithm that determines the score based on a weighted average of the employee data for each employee. For example, the average can be weighted by determining relative risk of any particular risk category based on the ratio of the average health spending for all individuals in the risk category to the average health spending for all individuals in all risk categories.

The risk assessment model uses data to identify underlying conditions and assign a risk score. For example, the risk assessment model can use health care claims data from a previous time period to determine a risk assessment score. The risk assessment score can be used to risk-adjust payments to insurance carriers in order for an insurance carrier to underwrite the insurance policy for the first organization.

Alternatively, in another embodiment, the computer system can obtain the risk assessment score from an insurance carrier or an underwriter. The insurance carrier or the underwriter can determine the risk assessment score based on the first organizational data obtained at 402. In this embodiment, the risk assessment score can be transmitted by the insurance carrier or underwriter to the computer system via a network.

At 406, the computer system can determine a plurality of insurance plans for the first organization based on the risk assessment score of the first organization. Each insurance plan in the plurality of insurance plans can have a value (e.g., price) and a coverage plan.

In some instances, the first organization and a second organization can be part of a professional employer organization (PEO). The method 400 can further include the computer system obtaining second organizational data associated with the second organization. The second organization data including employee data of the second organization. Additionally, the computer system can determine a risk assessment score of the second organization based on the employee data of the second organization. Furthermore, the determination of the plurality of insurance plans for the first organization at 406 can be further based on the risk assessment score of the second organization.

At 408, the computer system can rank the plurality of insurance plans based on the value (e.g., price) and the coverage plan of each insurance plan in the plurality of insurance plans. The computer system can rank the plurality of insurance plans using machine-learned techniques described herein. In some instances, the plurality of insurance plans can be ranked based on a likelihood that an employee will select the insurance plans. For example, the higher the likelihood that a specific insurance plan will be selected by an employee, the higher the ranking of the specific insurance plan. In some other instances, the plurality of insurance plans can be ranked based on the cost benefit of the insurance plan. For example, the cost benefit of the insurance plan can be determined by the computer system based on the insurance coverage and the value (e.g., price) of the specific insurance plan. In one example, the cost benefit of the insurance plan increases when the value (e.g., price) of the insurance plan decreases, and the cost benefit of the insurance plan increases when the insurance coverage improves (e.g., high limit of coverage, low out-of-pocket cost).

At 410, the computer system can present, using a user interface, an insurance report based on the ranking of the plurality of insurance plans. In some instances, the user interface can be presented on a user device of an HR administrator of the first organization. For example, the computing system 110 in FIG. 1 can be associated with an HR administrator or employee of the first organization, and the user interface can be presented on the output device 124 (e.g., display). Subsequently, the HR administrator or employee can provide a user input using the one or more input device 122 of the computing system 110.

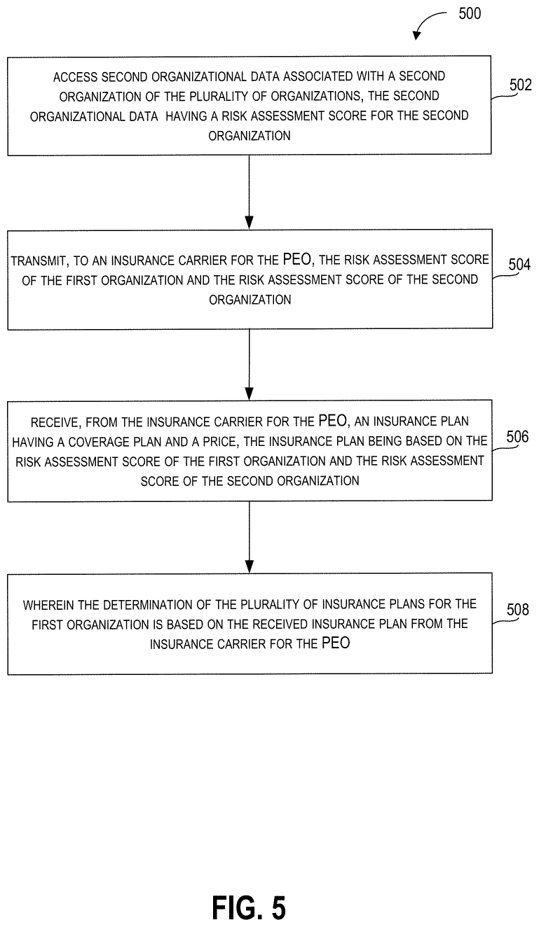

FIG. 5 depicts a flow diagram of an example method 500 for obtaining an insurance plan from an insurance carrier, according to example embodiments of the present disclosure. One or more portions of the method 500 can be executed and/or implemented on one or more computing devices or computing systems including, for example, the computing system 110, the remote computing system 130, the one or more computing devices 152, the computing device 200, the computing system 302, the computing system 306, and/or the computing system 310. In addition, one or more portions of the method 500 can be executed or implemented as an algorithm on the hardware devices or systems disclosed herein. FIG. 5 depicts steps performed in a particular order for purposes of illustration and discussion. As such, those of ordinary skill in the art, using the disclosures provided herein, will understand that various steps of any of the methods disclosed herein can be adapted, modified, rearranged, omitted, and/or expanded without deviating from the scope of the present disclosure.

In some instances, method 400 can further include the operations described in method 500. As previously discussed, the management system of the PEO can group together multiple organizations in order to obtain economies of scale and reduce cost.

According to some embodiments, the computing system of method 500 can implement an organizational management platform to manage applications (e.g., application 304, application 308) for an organization. The computing system can include one or more databases (e.g., one or more memory devices 116, one or more memory devices 136, one or more memory device 156, one or more memory devices 202) that collectively store organizational data (e.g., data 118, data 138, data 158, organizational data 203, organizational data 311) associated with the organization. In some instances, the computer system can include one or more processors, one or more databases, and one or more memory devices. The one or more databases can store organizational data associated with a plurality of organizations. The plurality of organizations can be part of a professional employer organization (PEO). The one or more memory devices can store instructions that, when executed by the one or more processors, cause the computer system to perform operations described in method 400.

At 502, a computer system can access second organizational data associated with a second organization of the plurality of organization. The computer system at 502 can be an example of the management system described herein. The second organizational data having a risk assessment score for the second organization. The accessing performed at 502 can be similar to the techniques described in the accessing process at 402.

At 504, the computer system can transmit to an insurance carrier for the PEO, the risk assessment score of the first organization and the risk assessment score of the second organization. For example, the computer system can be computing system 110 of FIG. 1 and the insurance carrier can be the one or more computing devices 152 of FIG. 1. The risk assessment score can be transmitted using the network 102 of FIG. 1.

At 506, the computer system can receive from the insurance carrier for the PEO, an insurance plan having a coverage plan and a value (e.g., price). The insurance plan can be based on the risk assessment score of the first organization and the risk assessment score of the second organization. For example, the computer system can be computing system 110 of FIG. 1 and the insurance carrier can be the one or more computing devices 152 of FIG. 1. The insurance plan can be transmitted and received using the network 102 of FIG. 1. The insurance plan at 506 can include insurance data 205 and price data 206 as described in FIG. 2.

At 508, the computing system can include the insurance plan received at 506 as part of the plurality of insurance plans for the first organization that is determined at 406.

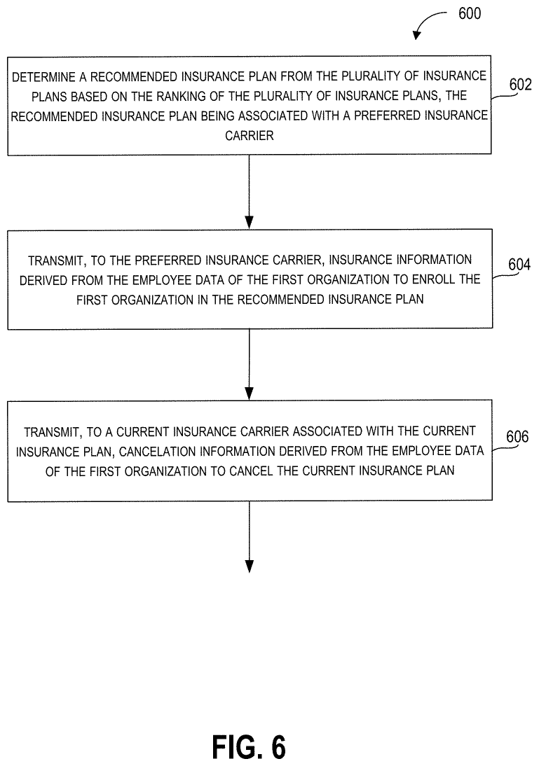

FIG. 6 depicts a flow diagram of an example method 600 for automatically enrolling in an insurance plan and automatically canceling an old insurance plan, according to example embodiments of the present disclosure. One or more portions of the method 600 can be executed and/or implemented on one or more computing devices or computing systems including, for example, the computing system 110, the remote computing system 130, the one or more computing devices 152, the computing device 200, the computing system 302, the computing system 306, and/or the computing system 310. In addition, one or more portions of the method 600 can be executed or implemented as an algorithm on the hardware devices or systems disclosed herein. FIG. 6 depicts steps performed in a particular order for purposes of illustration and discussion. As such, those of ordinary skill in the art, using the disclosures provided herein, will understand that various steps of any of the methods disclosed herein can be adapted, modified, rearranged, omitted, and/or expanded without deviating from the scope of the present disclosure.

At 602, a computer system can determine a recommended insurance plan from the plurality of insurance plans based on the ranking of the plurality of insurance plans. The recommended insurance plan can be associated with a preferred insurance carrier. The computer system at 602 can be an example of the management system described herein. The recommended insurance plan at 506 can be an example of the insurance data 205 and price data 206 as described in FIG. 2.

At 604, the computer system can transmit to the preferred insurance carrier, insurance information derived from the employee data of the first organization to enroll the first organization in the recommended insurance plan. The preferred insurance carrier can be transmitted via network 102 in FIG. 1.

At 606, the computer system can transmit to a current insurance carrier associated with the current insurance plan, cancelation information derived from the employee data of the first organization to cancel the current insurance plan. For example, the computer system can be computing system 110 of FIG. 1 and the insurance carrier can be the one or more computing devices 152 of FIG. 1. The cancelation information (e.g., cancelation request) can be transmitted, by the computer system at 606, to the current insurance carrier using the network 102 in FIG. 1.

In some instances, the insurance information transmitted at 604 and the cancelation information transmitted at 606 can be derived from the employee data of the first organization without requiring additional user input from an employee of the first organization. The cancelation information can be an electronic form that is automatically filled in by the computer system based on the employee data (e.g., employee data 204) of the first organization.

The enrollment or cancelation forms can be auto generated, and automatically filled in by the computer system. Additionally, the forms can be automatically transmitted (e.g., emailed, faxed) to the insurance carriers. In some instances, the forms (e.g., cancelation information, enrollment information) can be transmitted to the insurance carrier via the electronic data interface of the insurance carrier.

In some instances, the insurance information transmitted to the preferred insurance carrier at 604 occurs after a certain period of time has lapsed since the report was presented on the user interface at 410.

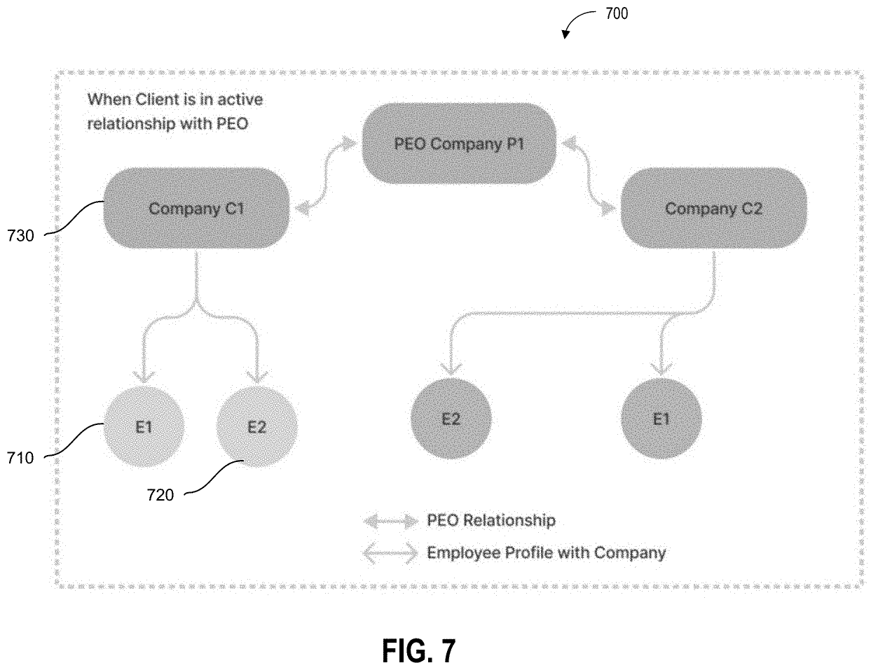

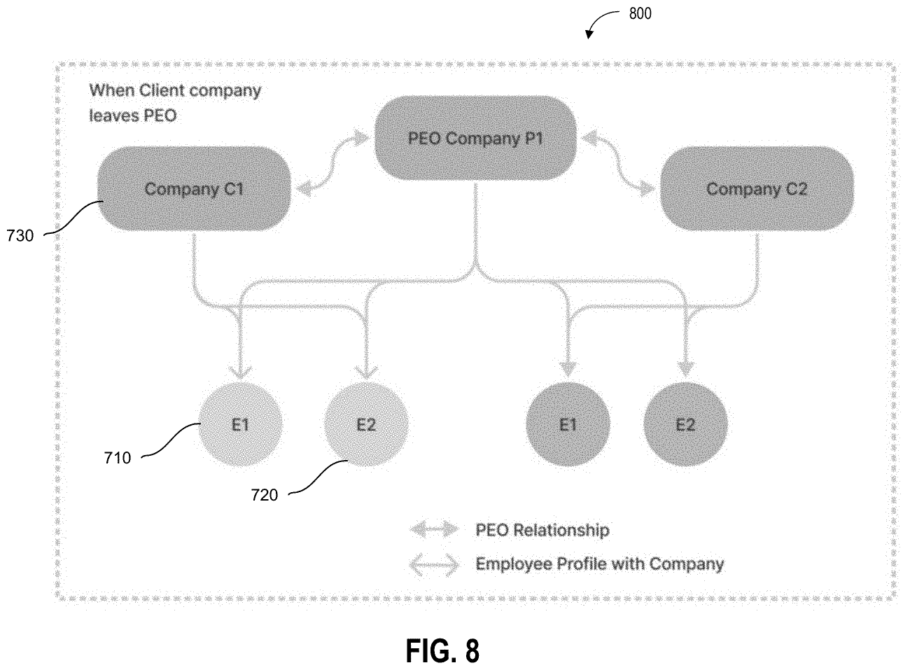

According to some embodiments, the management system can manage an organization's benefits once the organization leaves the PEO. PEO become co-employees of all employees of the plurality of organizations that have joined the PEO. Once an employee ceases employment with the current employer (e.g., first organization), the employee can continue coverage from the previous employer's coverage through Consolidated Omnibus Budget Reconciliation Act (COBRA). As part of co-employment, the management system can provide an option for employees that are no longer with the current employer to continue insurance coverage through COBRA. Additionally, the management system can seamlessly manage COBRA for the plurality of organizations, as described in the scenarios depicted in FIGS. 7 and 8. The management system can also include a software system that is specifically tailored to manage COBRA for employees whose employers are no longer part of the PEO.

FIGS. 7 and 8 and depicts scenarios 700, 800 of an organization or an employee leaving a PEO, according to example embodiments of the present disclosure. For example, client company C1 has joined PEO entity P1. The management system can create a company for the P1 entity in the PEO so that the management system can manage payroll tax filing and COBRA for employees who are no longer employed by the PEO entity. In these scenarios 700, 800, employees E1 710 and E2 720 can be US salaried full-time employees of company C1 730. Additionally, employee E1 710 and E2 720 both have enrolled in PEO coverage in company C1 730.

In scenario 700, the employee no longer works for the employer, but the employer is still part of the PEO. When employee E1 710 leaves company C1 730 and company C1 730 continues the relationship with PEO, E1 710 can get the option by the management system to make a plan selection to continue coverage through COBRA. Employees can either choose or waive coverage. The management system can manage the insurance coverage under COBRA if E1 710 decides to continue coverage under COBRA.

In scenario 800, the employee becomes COBRA eligible as the company P1 730 leaves the PEO. When company C1 decides to leave PEO, all active employees (e.g., employee E2 720) also become eligible to continue PEO coverage through COBRA. For example, the active employees become COBRA eligible due to employer's termination from PEO. The company might also have some employees (e.g., employee E1 710 from scenario 700) who are already enrolled in PEO coverage through COBRA. After termination from PEO, C1 730 can leave the PEO platform.

To support managing COBRA for both COBRA eligible employees due to employer's termination from PEO and already COBRA-enrolled employees, the management system can move all employees to company P1 in the terminated state. Company P1 can already have an insurance setup for PEO coverage and hence the management can continue managing COBRA in company P1. Now both employees E1 710 and E2 720 can have profiles in the management system with companies C1 and P1. In P1, the management system can just manage PEO COBRA.

Numerous details are set forth in the foregoing description. However, it will be apparent to one of ordinary skills in the art having the benefit of this disclosure that the present disclosure may be practiced without these specific details. In some instances, structures and devices are shown in block diagram form, rather than in detail, to avoid obscuring the present disclosure.

Some portions of the detailed description have been presented in terms of processes and symbolic representations of operations on data bits within a computer memory. Here, a process can include a self-consistent sequence of steps leading to a result. The steps can include those requiring physical manipulations of physical quantities. These quantities can take the form of electrical or magnetic signals capable of being stored, transferred, combined, compared, and otherwise manipulated. These signals can be referred to as bits, values, elements, symbols, characters, terms, numbers, or the like.

These terms and similar terms can be associated with physical quantities and can represent labels applied to these quantities. The terms including “obtaining,” “parsing,” “analyzing,” “accessing,” “determining,” “identifying,” “adjusting,” “modifying,” “transmitting,” “receiving,” “processing” “generating,” or the like, can refer to the actions and processes of a computer system, a computing device, or similar electronic computing device, that manipulates and transforms data represented as physical (e.g., electronic) quantities within the computer system's registers and memories into other data that can be similarly represented as physical quantities within the computer system's memories, registers, or other information storage device, data transmission device, or data processing device.

Certain examples of the present disclosure can relate to an apparatus for performing the operations described herein. This apparatus may include a computing device that is activated or reconfigured by a computer program comprising electronic instructions stored in the computing device. Such a computer program may be stored in a computer readable storage medium, which can include any type of storage. For example, the storage can include hard disk drives, solid state drives, floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The above description is intended to be illustrative, and not restrictive. The scope of the disclosure can therefore be determined with reference to the claims.

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

1. A computer system comprising:
one or more processors;
one or more databases that store organizational data associated with a plurality of organizations, wherein the plurality of organizations are part of a professional employer organization (PEO);
one or more memory devices that store instructions that, when executed by the one or more processors, cause the computer system to perform operations, the operations comprising:
obtaining first organizational data associated with a first organization of the plurality of organizations, the first organization data including employee data of the first organization and a current plan;
determining a risk assessment score of the first organization based on the employee data of the first organization;
transmitting, to an insurance carrier for the PEO, coverage data derived from the current insurance plan;
receiving, from the insurance carrier for the PEO, an insurance plan having a coverage plan and a value, the coverage plan being similar to the coverage data;
determining a plurality of insurance plans for the first organization based on the risk assessment score of the first organization and the received insurance plan from the insurance carrier for the PEO, each insurance plan in the plurality of insurance plans having a value and a coverage plan;
ranking the plurality of insurance plans based on the value and the coverage plan of each insurance plan in the plurality of insurance plans; and
presenting, using a user interface, an insurance report based on the ranking of the plurality of insurance plans.

2. The computer system of claim 1, wherein the operations further comprising:
accessing second organizational data associated with a second organization of the plurality of organizations; the second organizational data having a risk assessment score for the second organization;
transmitting, to an insurance carrier for the PEO, the risk assessment score of the first organization and the risk assessment score of the second organization;
receiving, from the insurance carrier for the PEO, an insurance plan having a coverage plan and a value, the insurance plan being based on the risk assessment score of the first organization and the risk assessment score of the second organization; and
wherein the determining the plurality of insurance plans for the first organization is based on the received insurance plan from the insurance carrier for the PEO.

3. The computer system of claim 1, wherein the first organization and a second organization are part of a professional employer organization (PEO), and wherein the operations further comprising:
obtaining second organizational data associated with the second organization, the second organization data including employee data of the second organization;
determining a risk assessment score of the second organization based on the employee data of the second organization; and
wherein the determining of the plurality of insurance plans for the first organization is further based on the risk assessment score of the second organization.

4. The computer system of claim 1, wherein the operations further comprising:
determining a recommended insurance plan from the plurality of insurance plans based on the ranking of the plurality of insurance plans, the recommended insurance plan being associated with a new insurance carrier; and
transmitting, to the new insurance carrier, insurance information derived from the employee data of the first organization to enroll the first organization in the recommended insurance plan.

5. The computer system of claim 4, wherein the first organization data includes a current insurance plan, wherein the operations further comprising:
transmitting, to a current insurance carrier associated with the current insurance plan, cancelation information derived from the employee data of the first organization to cancel the current insurance plan.

6. The computer system of claim 5, wherein the insurance information and the cancelation information are derived from the employee data of the first organization without requiring additional user input from an employee of the first organization.

7. The computer system of claim 4, wherein the insurance information transmitted to the new insurance carrier occurs after a certain period of time has lapsed since the report was presented on the user interface.

8. The computer system of claim 1, wherein the operations further comprising:
receiving a user input associated with the selection of a selected insurance plan from the plurality of insurance plans; and
enrolling the first organization in the selected insurance plan in response to receiving the user input.

9. The computer system of claim 1, wherein the first organizational data includes a current insurance plan, and wherein the ranking of the plurality of insurance plans is further based on a comparison of the plurality of insurance plan with the current insurance plan.

10. The computer system of claim 1, wherein the operations further comprising:
determining a tier for the first organization rating based on the risk assessment score of the first organization; and
wherein the value for each insurance plan in the plurality of insurance plans is based on the tier rating.

11. The computer system of claim 1, wherein the first organization data includes a current insurance plan, wherein the operations further comprising:
transmitting, to an insurance carrier for the PEO, coverage data derived from the current insurance plan;
receiving, from the insurance carrier for the PEO, an insurance plan having a coverage plan and a value, the coverage plan being similar to the coverage data; and
wherein the determining the plurality of insurance plans for the first organization is based on the received insurance plan from the insurance carrier for the PEO.

12. The computer system of claim 1, wherein the first organization data includes a current insurance plan associated with a current insurance carrier, wherein the operations further comprising:
transmitting, to the insurance carrier, coverage data derived from the current insurance plan and the employee data of the first organization to automatically renew the current insurance plan.

13. A computer-implemented method comprising:
storing, by one or more databases, organizational data associated with a plurality of organizations, wherein the plurality of organizations are part of a professional employer organization (PEO);
obtaining, by one or more computing devices, first organizational data associated with a first organization of the plurality of organizations, the first organization data including employee data of the first organization and a current plan;
determining, by the one or more computing devices, a risk assessment score of the first organization based on the employee data of the first organization;
transmitting, to an insurance carrier for the PEO, coverage data derived from the current insurance plan;
receiving, from the insurance carrier for the PEO, an insurance plan having a coverage plan and a value, the coverage plan being similar to the coverage data;
determining, by the one or more computing devices, a plurality of insurance plans for the first organization based on the risk assessment score of the first organization and the received insurance plan from the insurance carrier for the PEO, each insurance plan in the plurality of insurance plans having a value and a coverage plan;
ranking, by the one or more computing devices, the plurality of insurance plans based on the value and the coverage plan of each insurance plan in the plurality of insurance plans; and
presenting, using a user interface, an insurance report based on the ranking of the plurality of insurance plans.

14. The computer-implemented method of claim 13, further comprising:
accessing second organizational data associated with a second organization of the plurality of organizations; the second organizational data having a risk assessment score for the second organization;
transmitting, to an insurance carrier for the PEO, the risk assessment score of the first organization and the risk assessment score of the second organization;
receiving, from the insurance carrier for the PEO, an insurance plan having a coverage plan and a value, the insurance plan being based on the risk assessment score of the first organization and the risk assessment score of the second organization; and
wherein the determining the plurality of insurance plans for the first organization is based on the received insurance plan from the insurance carrier for the PEO.

15. The computer-implemented method of claim 13, wherein the first organization and a second organization are part of a professional employer organization (PEO), the method further comprising:
obtaining second organizational data associated with the second organization, the second organization data including employee data of the second organization;
determining a risk assessment score of the second organization based on the employee data of the second organization; and
wherein the determining of the plurality of insurance plans for the first organization is further based on the risk assessment score of the second organization.

16. The computer-implemented method of claim 13, further comprising:
determining a recommended insurance plan from the plurality of insurance plans based on the ranking of the plurality of insurance plans, the recommended insurance plan being associated with a new insurance carrier; and
transmitting, to the new insurance carrier, insurance information derived from the employee data of the first organization to enroll the first organization in the recommended insurance plan.

17. The computer-implemented method of claim 16, wherein the first organization data includes a current insurance plan, the method further comprising:
transmitting, to a current insurance carrier associated with the current insurance plan, cancelation information derived from the employee data of the first organization to cancel the current insurance plan.

18. The computer-implemented method of claim 13, further comprising:
receiving a user input associated with the selection of a selected insurance plan from the plurality of insurance plans; and
enrolling the first organization in the selected insurance plan in response to receiving the user input.

19. The computer-implemented method of claim 13, further comprising:
determining a tier for the first organization rating based on the risk assessment score of the first organization; and
wherein the value for each insurance plan in the plurality of insurance plans is based on the tier rating.

20. One or more non-transitory computer-readable media that collectively store instructions that, when executed by one or more computing devices, cause the one or more computing devices to perform operations, the operations comprising:
accessing, from one or more databases, organizational data associated with a plurality of organizations, wherein the plurality of organizations are part of a professional employer organization (PEO);
obtaining first organizational data associated with a first organization of the plurality of organizations, the first organization data including employee data of the first organization and a current plan;
determining a risk assessment score of the first organization based on the employee data of the first organization;
transmitting, to an insurance carrier for the PEO, coverage data derived from the current insurance plan;
receiving, from the insurance carrier for the PEO, an insurance plan having a coverage plan and a value, the coverage plan being similar to the coverage data;
determining a plurality of insurance plans for the first organization based on the risk assessment score of the first organization and the received insurance plan from the insurance carrier for the PEO, each insurance plan in the plurality of insurance plans having a value and a coverage plan;
ranking the plurality of insurance plans based on the value and the coverage plan of each insurance plan in the plurality of insurance plans; and
causing the presentation of an insurance report on a user interface, the insurance report being generated based on the ranking of the plurality of insurance plans.
